(19) United States
(12) Patent Application Publication
(10) Pub. No.: US 2024/0106029 A1
(43) Pub. Date: Mar. 28, 2024

(54) MODULAR BATTERY PACK

(71) Applicant: Xerotech Limited, Claregalway, County Galway (IE)

(72) Inventors: Barry FLANNERY, Claregalway (IE); Sean MCFADDEN, Claregalway (IE); Meaghan COLLINS, Claregalway (IE); Neil QUINN, Claregalway (IE)

(21) Appl. No.: 18/263,288

(22) PCT Filed: Jan. 27, 2022
(86) PCT No.: PCT/EP2022/051957

§ 371 Date: Jul. 27, 2023

(30) Foreign Application Priority Data
Jan. 27, 2021 (GB) 2101121.8

(51) Int. Cl. H01M 10/6567; H01M 10/658; H01M 50/213; H01M 50/289; H01M 50/507

(52) U.S. Cl. CPC H01M 10/6567; H01M 10/658; H01M 50/213; H01M 50/289; H01M 50/507

(57) ABSTRACT

A battery pack (1) comprises one or more battery modules (10). A battery module (10) comprises one or more cells (120) and a thermal management arrangement (140) for thermally managing the one or more cells (120). The thermal management arrangement (140) comprises at least one thermal management duct (141), an intake-side fluid delivery arrangement (200c) and an outlet-side fluid delivery arrangement (200d). The inlet-side fluid delivery arrangement (200c) is in fluid communication with the outlet-side fluid delivery arrangement (200d) via the at least one thermal management duct (141). Each fluid delivery arrangement (200) comprises first and second fluid connection arrangements for allowing a thermal management fluid to enter and/or exit the thermal management arrangement (140).

The present invention relates to a modular battery pack, particularly a modular battery pack for use in mobile applications such as electric vehicles.

To reduce the amount of greenhouse gasses emitted into the atmosphere each year many governments actively encourage the adoption of technologies which emit less carbon. For example, the automotive industry is undergoing rapid changes due to the gradual phase out of petroleum-based power sources in favour of electric power sources. The speed of change in the consumer car industry is particularly rapid and has led to an explosion of new battery technologies based on thermally managed lithium-ion cells. It is becoming clear that in order to meet climate change reduction targets it will be necessary to replicate these changes much more widely—industrial vehicles and machinery will also need to ‘go electric’ if targets are to be met.

Developing green power solutions for industrial and mobile applications is an expensive and time-consuming technical task. When seeking to replace e.g. a diesel engine in an industrial vehicle with a battery pack it is rare to find an off-the-shelf battery solution able to provide the necessary power profile and to fit perfectly into the required volume. Such conversion usually requires a re-design of the structure of the machine or vehicle so that it can accommodate an off-the-shelf battery solution the design of a bespoke battery solution to fit within the existing structure, or both. Furthermore, the safety and thermal management requirements of batteries are fundamentally different to those of petroleum-based technologies, making it even harder to incorporate an off-the-shelf solution into an existing design.

While the development of custom-engineered battery packs and/or accommodating structures can be cost effective in high-volume manufacturing of consumer vehicles, this level of cost is often prohibitive in lower-volume manufacturing settings. Low-volume manufacturers of cranes, plant machinery and mining equipment do not enjoy the economies of scale which would justify the costs of an all-electric conversion. There exists a need for an electrical power solution that can be incorporated into a wide variety of machinery and can be easily adapted to satisfy a range of power, thermal management and volume requirements.

It is an object of the invention to obviate or mitigate the problems outlined above. In particular, it is an object of the invention to provide an electrical power solution that can be incorporated into a wide variety of machinery.

It is a further object of the invention to provide an electrical power solution that can be easily adapted to satisfy a range of design, power and volume requirements.

It is a further object of the invention to provide an electrical power solution that can be easily adapted to satisfy a range of safety and thermal management requirements.

It is a further object of the invention to provide an electrical power solution that can be adapted for incorporation into an existing vehicle design.

It is a further object of the invention to provide an electrical power solution that can be retrofitted in an existing vehicle or machine.

It is a further object of the invention to provide a battery pack that is more adjustable than prior art battery packs.

According to a first aspect of the invention there is provided a battery module comprising one or more cells and a thermal management means for thermally managing the one or more cells, wherein the thermal management means comprises at least one thermal management duct, an intake-side fluid delivery means and an outlet-side fluid delivery means, wherein the inlet-side fluid delivery means is in fluid communication with the outlet-side fluid delivery means via the at least one thermal management duct and wherein each fluid delivery means comprises first and second fluid connection means for allowing a thermal management fluid to enter and/or exit the thermal management means. Advantageously, an adjustable number of such battery modules can be incorporated into a battery pack so that any particular volumetric and/or electrical requirements can be met.

According to a further aspect of the invention there is provided a battery module comprising: a battery module housing; one or more cells located within the battery module housing; a thermal management means for thermally managing the one or more cells; and a battery module electrical connection means for providing electrical connections between the battery module and a further battery module and/or an external load. Advantageously, one or more battery modules can be incorporated into a battery pack in a variety of orientations and locations so that any particular volumetric and/or electrical requirements can be met.

According to another aspect of the invention there is provided a battery pack comprising one or more battery modules.

Preferably, the battery module is locatable within a battery pack.

Preferably, the battery pack comprises at least one battery module.

Preferably, the battery pack comprises a plurality of battery modules.

Preferably, the battery pack comprises at least three battery modules.

Preferably, the battery module is connectable to one or more further identical battery modules.

Ideally, the battery module comprises a battery module housing.

Ideally, the battery module housing comprises an upper housing member.

Preferably, the battery module housing comprises a lower housing member.

Preferably, the upper housing member and lower housing member are substantially identical.

Preferably, each of the upper and lower housing members comprise a substantially planar base.

Preferably, each of the upper and lower housing members comprise two side walls.

Preferably, each of the upper and lower housing members comprise two end walls.

Preferably, the respective side walls and end walls extend in a direction which is substantially perpendicular to each base.

Preferably, the side walls of the upper and lower housing members comprise one or more recesses.

Preferably, the end walls of the upper and lower housing members comprise one or more recesses.

Preferably, the battery module housing comprises two opposing side walls.

Ideally, the side wall recesses form apertures in the side walls of the battery module housing.

Ideally, the electrical connections can be made to the battery module terminals through the side wall recesses/apertures.

Preferably, the end wall recesses form apertures in the end walls of the battery module housing.

Preferably, electrical and/or fluid connections can be made to the battery module through the end wall recesses/apertures.

Preferably, the battery module comprises an upper surface and a lower surface.

Preferably, the battery module comprises one or more side surfaces.

Preferably, the battery module comprises one or more end surfaces.

Preferably, the upper surface is formed by the base of the upper housing member.

Preferably, the lower surface is formed by the base of the lower housing member.

Preferably, the side surfaces are formed by the side walls of the upper and lower housing members and terminal busbars of the battery module.

Ideally, the end surfaces are formed by the end walls of the upper and lower housing members, the busbars of the battery module, and the fluid delivery means.

Preferably, the battery module comprises at least one cell.

Preferably, the battery module comprises one or more cells.

Preferably, the battery module comprises a plurality of cells.

Preferably, the or each cell is electrically connected to a busbar.

Preferably, the battery module comprises one or more cylindrical cells.

Preferably, the battery module comprises an array of cylindrical cells.

Preferably, the battery module comprises a predetermined number of cells arranged in a regular array.

Preferably, the battery module comprises a multiple of six or twelve cells.

Preferably, the cells are in a close-packed hexagonal array.

Preferably, the battery module comprises a close-packed hexagonal array of cylindrical cells.

Preferably, the minimum separation between the ceils is 2 mm.

Preferably, the battery module comprises one or more cells located within the battery module housing.

Preferably, the battery module comprises a battery module electrical connection means.

Preferably, the battery module comprises a battery module electrical connection means for providing electrical connections between the battery module and a component such as a further battery module, a busbar, an interconnect and/or an external load.

Preferably, the battery module electrical connection means comprises one or more busbars.

Preferably, the battery module electrical connection means comprises positive and negative terminals.

Preferably, the positive and negative terminals are located on the opposing side walls of the housing.

Preferably, the battery module comprises a thermal management means.

Preferably, the battery module comprises a thermal management means for thermally managing the one or more cells.

Preferably, the thermal management means is configured to allow fluid connections to be made to the battery module in a plurality of locations and/or orientations.

Ideally, the or each thermal management means is adapted to thermally manage the cell(s).

Ideally, the or each thermal management means is adapted to heat and/or cool the cell(s).

Preferably, the thermal management means comprises an inlet-side fluid delivery means.

Preferably, the thermal management means comprises an outlet-side fluid delivery means.

Preferably, the inlet-side fluid delivery means and the outlet-side fluid delivery means are substantially identical.

Preferably, the thermal management means comprises one or more thermal management ducts.

Preferably, the thermal management means comprises a plurality of thermal management ducts.

Preferably, the thermal management means comprises one or more substantially parallel thermal management ducts.

Preferably, the thermal management means comprises one or more manifold ducts.

Preferably, the thermal management means comprises one or more serpentine ducts.

Preferably, the or each thermal management duct is a flexible duct.

Preferably, the or each thermal management duct is flexible and/or inflatable.

Preferably, the or each thermal management duct is made from an inflatable plastics material. An inflatable plastics material is advantageous as the material is intrinsically electrically insulating, lightweight and does not corrode or chemically interact with a coolant such as a glycol water mix.

Ideally, the or each thermal management duct is made from polyethylene (PE).

Preferably the or each thermal management duct is made from low-density polyethylene (LDPE), linear low-density polyethylene (LLDPE) or high-density polyethylene (HOPE).

Preferably the or each thermal management duct includes one or more thermally conductive additives. Thermally conductive additives provide the advantage that they can improve the thermal conductivity of the duct material.

Preferably the thermally conductive additives may compose a thermally conductive filler material.

Preferably the thermally conductive additives may comprise particles of a thermally conductive filler material.

Preferably the particles have a diameter of 1-10 nm.

Preferably the particles have a diameter of <5 μm.

Preferably the thermally conductive filler material is incorporated into the inflatable plastics material.

Ideally the or each thermal management duct comprises a matrix material and a thermally conductive filler material.

Preferably the matrix material comprises the inflatable plastics material such as polyethylene (PE), low-density polyethylene (LDPE), linear low-density polyethylene (LLDPE) or high-density polyethylene (HDPE).

Preferably the thermally conductive filler comprises a carbon-based filler material.

Preferably the thermally conductive filler comprises carbon, carbon black, graphite, graphene, multi-walled carbon nanotubes or single-wall carbon nanotubes.

Optionally the thermally conductive filler comprises an inorganic filler material.

Optionally the thermally conductive filler comprises a ceramic filler material.

Optionally the thermally conductive filler comprises aluminium oxide, silicon carbide, boron nitride, silicon nitrate, alumina, aluminium nitride or zinc oxide.

Preferably the thermally conductive filler comprises a mixture of different types of particles.

Preferably the thermally conductive filler comprises a mixture of at least two different types of particles.

Ideally the or each duct comprises polyethylene, a carbon-based filler material and a ceramic-based filler material.

Preferably the or each duct comprises polyethylene, graphite particles and boron nitride particles.

Preferably the or each duct comprises up to 30% additives.

Preferably the ratio of carbon-based filler material to ceramic-based filler material is between 1:0 and 0:1.

Ideally the thermal conductivity of the or each thermal management duct is >=0.8 W/m·K.

Ideally the thermal conductivity of the or each thermal management duct is approximately 1 W/m·K.

Preferably, the walls of the or each flexible duct are between 50 μm and 150 μm thick. Advantageously, the thickness if the walls allows for good thermal transfer properties between the or each duct and the cells.

Preferably, the or each thermal management duct is a single-lumen duct.

Preferably, the or each thermal management duct is a multi-lumen duct.

Optionally the or each thermal management duct is a rigid duct made from e.g. aluminium or copper.

Preferably, the or each thermal management duct is positioned adjacent to and/or between cells in a battery module.

Preferably, the or each thermal management duct is in a substantially inflated state.

Preferably, the or each thermal management duct is inflated.

Preferably, the or each thermal management duct expands into contact with the side walls of one or more cells.

Preferably, the or each thermal management duct is in an expanded state such that said thermal management duct has a shape which conforms to the surface shape of one or more cells.

Preferably, the or each thermal management duct is in direct contact with one or more cells.

Preferably, the or each thermal management duct is in indirect contact with one or more cells.

Optionally, the or each thermal management duct is in indirect contact with one or more cells via an interface region or interface material.

Optionally, the or each thermal management duct is in indirect contact with one or more cells via an interface region or interface material such as a casing sheath surrounding the cells.

Preferably, the or each thermal management duct is in indirect contact with one or more cells via a thermally conductive filler material such as a conductive paste or adhesive.

Preferably, the battery module comprises a potting means.

Preferably, the potting means is poured into the battery module in a liquid state and sets, cures or hardens.

Preferably, in its set, cured or hardened state, the potting means is substantially rigid such that it secures the cells and the thermal management ducts in position within the battery module.

Preferably, the potting means is adhesively attached to the or each duct.

Preferably, the potting means provides total external support to the or each duct.

Preferably, the potting means prevents excessive expansion and/or bursting of the or each duct.

Preferably, the potting means maintains each duct in an open configuration such that coolant is able to flow easily through the or each duct.

Ideally, the potting means is an expandable potting means.

Preferably, the potting means comprises a thermally-insulating potting material such as intumescent polyurethane foam. Advantageously polyurethane foam is lighter than other potting materials and therefore provides a battery module having a low overall weight.

Preferably, the potting means. When in the expanded state, substantially fills gaps within the or each module.

Optionally, the potting means comprises a thermosetting plastic, silicone rubber gel or epoxy resin.

Preferably, the battery module comprises one or more sensing means.

Preferably, the sensing means are used to measure the temperature of the cells.

Preferably, the sensing means are located on a flexible carrier.

Preferably, the flexible carrier is a flexible PCB.

Preferably, the flexible carrier is attachable to a duct.

Preferably, the sensing means are located between a thermal management duct and one or more cells.

Preferably, the sensing means comprises one or more sensors.

Preferably, the sensors comprise pressure sensors, temperature sensors, voltage sensors and/or liquid/moisture sensors.

Preferably, the sensors are mounted in arrays.

Preferably, the sensors are mounted in arrays on the flexible carer. Advantageously, the sensors being mounted in arrays allows the performance and physical characteristics of the battery pack to be mapped, as well as determining the differentials of quantities throughout the pack. For example, fluid flow rates and temperature change rates can be inferred/predicted.

Preferably, the sensors are mounted in linear arrays.

Optionally, the sensors are mounted in polar arrays.

Preferably, the carrier comprises conductive traces. Advantageously the use of conductive traces allows the sensors on the carrier to be operably connected to e.g. the slave board of the battery module allowing the temperature of the cells to be transmitted to and analysed by e.g. the battery pack management means.

According to a further aspect of the invention there is provided a battery module and/or a battery pack comprising a fluid delivery means.

According to a further aspect of the invention there is provided a fluid delivery means for delivering a thermal management fluid to one or more thermal management ducts locatable within a battery module and/or a battery pack, the fluid delivery means comprising: a primary conduit adapted to provide a path for fluid into and/or out of the fluid delivery means; and one or more distribution conduits adapted to provide a path for fluid into and/or out of the fluid delivery means; wherein each distribution conduit is in fluid communication with the primary conduit. Advantageously, the fluid delivery means provides a means by which fluid can be distributed within a battery pack to thermally manage multiple cells.

Preferably, the battery module comprises at least one fluid delivery means.

Preferably, the battery module comprises two fluid delivery means.

Preferably, the or each duct is operably connected to at least one fluid delivery means.

Ideally, the or each duct is operably connected to two fluid delivery means.

Preferably, the or each duct is sealably connected to at least one fluid delivery means.

Preferably, the or each duct is welded to at least one fluid delivery means.

Preferably, the or each fluid delivery means is adapted for delivering a thermal management fluid to one or more thermal management ducts locatable within a battery module and/or battery pack.

Preferably, at least one fluid delivery means comprises a primary conduit.

Preferably, the or each fluid delivery means comprises at least one primary conduit.

Preferably, the or each fluid delivery means comprises at least one primary conduit adapted to provide a path for fluid into and/or out of the fluid delivery means.

Preferably, the fluid delivery means comprises a body.

Preferably, the fluid delivery means comprises a body which is formed of front and rear members.

Preferably, the primary conduit forms part of the front member.

Preferably, the or each fluid delivery means comprises a main chamber.

Preferably, the front member partially encloses the main chamber.

Preferably, each distribution conduit is attachable to the rear member of the body.

Preferably, the rear member partially encloses the main chamber.

Preferably, the main chamber is located within the body.

Preferably, the main chamber is fully enclosed by the front and rear members.

Preferably, the front and rear members are sealably attached to one another.

Ideally, the or each fluid delivery means is a header tank.

Preferably, the or each fluid delivery means, in use, is operably connected to one or more thermal management ducts within a battery module and/or a battery pack.

Preferably, the or each fluid delivery means, in use, is operably connected to a plurality of thermal management ducts within a battery module and/or a battery pack.

Preferably, the or each fluid delivery means, in use, is operably connected to one or more further fluid delivery means of one or more further battery modules.

Preferably, the primary conduit provides a fluid path into and/or out of the fluid delivery means.

Preferably, the or each primary conduit provides a fluid path into and/or out of a main chamber.

Preferably, the or each primary conduit comprises a first fluid connection means.

Preferably, the or each first fluid connection means is a fluid inlet.

Preferably, the or each primary conduit comprises a second fluid connection means.

Preferably, the or each second fluid connection means is a fluid outlet.

Preferably, the first fluid connection means of the primary conduit provides a fluid path into the fluid delivery means.

Preferably, the first fluid connection means of the primary conduit is connectable to a source of thermal management fluid.

Preferably, the second fluid connection means of the primary conduit provides a fluid path out of the fluid delivery means.

Preferably, a first fluid connection means is provided at a first end of the primary conduit.

Preferably, a second fluid connection means is provided at a second end of the primary conduit.

Preferably, the first end of the primary conduit is opposite the second end of the primary conduit.

Ideally, the primary conduit comprises a primary conduit wall.

Preferably, the primary conduit wall has a regular cross section.

Preferably, the primary conduit extends along an axis.

Preferably, the primary conduit has a main or major axis.

Preferably, the main or major axis of the primary conduit extends along the length of the primary conduit.

Preferably, the main or major axis of the primary conduit is substantially parallel to the direction of fluid flow through the primary conduit from the first fluid connection means to the second fluid connection means thereof.

Preferably, the main or major axis of the primary conduit is substantially parallel to the main or major axis of the primary conduit of a neighbouring fluid delivery means.

Preferably, the fluid delivery means comprises a first configuration in which the primary conduit is used to transport fluid to/from the main chamber.

Preferably, in the first configuration the first fluid connection means and second fluid connection means of the primary conduit are open so that fluid can pass into and out of the main chamber via the primary conduit.

Preferably, in the first configuration the perforable regions are unperforated.

Preferably, in the first configuration fluid is unable to pass into the main chamber via the perforable regions.

Preferably, the first fluid connection means of the primary conduit is connectable to a first and/or second fluid connection means of a further fluid delivery means.

Preferably, the second fluid connection means of the primary conduit is connectable to a first and/or second fluid connection means of a further fluid delivery means.

Preferably, the first fluid connection means and/or the second fluid connection means comprises attachment means.

Preferably, the or each attachment means comprises a flange.

Preferably, the or each attachment means comprises a channel for a receiving a seal.

Preferably, each flange comprises two sloped surfaces.

Preferably, the or each flange comprises a channel.

Ideally, the sloped surfaces are substantially opposite the surface of each flange in which the channel is formed.

Preferably, the or each channel is adapted to receive and retain part of a sealing means.

Preferably, the or each channel has a predetermined depth:

Preferably, the or each channel has a predetermined depth suitable for receiving at least a part of a sealing means.

According to a further aspect of the invention there is provided a battery pack comprising a sealing means.

According to a further aspect of the invention there is provided a seal means for providing a fluid-tight seal in a battery pack, the sealing means comprising a deformable annular body comprising first and second elongate side portions, wherein the sealing means is locatable between two retaining means in a battery pack. Advantageously, the sealing means is able to seal joins between neighbouring primary conduits/header tanks within the battery pack.

According to a further aspect of the invention there is provided a sealing means for providing a seal between fluid conduits in a battery pack or battery module, the sealing means comprising a deformable body, the deformable body comprising a central portion located between two retainable portions, wherein in use the retainable portions are locatable in retainment channels and wherein in the deformed state the central portion has an increased width. Advantageously, the sealing means is able to accommodate position tolerances between the respective ends of the conduits of primary conduits/header tanks within the battery pack.

Preferably, the sealing means is for providing a seal between fluid conduits in a battery pack.

Preferably, the sealing means is an o-ring.

Preferably, the sealing means comprises a deformable body.

Preferably, the sealing means comprises soft silicone or other suitable resilient material.

Preferably, the sealing means comprises rubber.

Preferably, the sealing means has a unitary body.

Preferably, the sealing means has a shore A hardness of less than 50.

Preferably, the sealing means has a shore A hardness greater than 15.

Preferably, the sealing means has a shore A hardness of between 30 and 40.

Preferably, the sealing means has a shore A hardness of between 33 and 37.

Preferably, the sealing means has a shore A hardness of 35.

Ideally, the sealing means is annular.

Preferably, the body comprises a central portion.

Preferably, the cross-sectional shape of the body comprises a central portion located between first and second retainable portions.

Preferably, the body comprises two retainable portions.

Preferably, the cross-sectional shape of the body comprises a central portion located between first and second retainable portions.

Preferably, the retainable portions protrude from the central portion.

Preferably, the retainable portions protrude from opposing sides of the central portion.

Preferably, the body comprises two elongate retainable portions.

Preferably, the cross-sectional shape of each retainable portion comprises first and second substantially straight edge portions.

Preferably, the first and second substantially straight edge portions are joined by a curved edge portion.

Preferably, the first and second substantially straight edge portions are joined by a semicircular edge portion.

Preferably, the central portion is located between two retainable portions.

Preferably, the central portion is wider than the retainable portions.

Preferably, the cross-sectional width of the central portion is greater than the cross-sectional width of each retainable portion.

Preferably, the central portion comprises first and second curved edge portions.

Preferably, the central portion comprises first and second semicircular edge portions.

Preferably, the maximum distance between the first and second substantially straight edge portions of each retainable portion is less than the maximum distance between the first and second curved edge portions of the central portion.

Preferably, the retainable portions are adapted to be located and retained within a retaining means.

Preferably, the retainable portions are adapted to be located and retained within the channels in the flanges of the fluid delivery means.

Preferably, the sealing means is substantially rectangular.

Preferably, the sealing means comprises a deformable annular body.

Preferably, the sealing means comprises first and second elongate side portions.

Preferably, the first and second elongate side portions are substantially straight.

Preferably, the first and second elongate side portions are substantially parallel.

Preferably, the first and second elongate side portions are of equal length.

Preferably, the body comprises first and second shortened side portions.

Preferably, the first and second shortened side portions are substantially straight.

Preferably, the first and second shortened side portions are substantially parallel.

Preferably, the first and second shortened side portions are of equal length.

Preferably, the seal means comprises one or more curved portions.

Preferably, the ends of neighbouring side portions are joined by at least one curved portion.

Preferably, the first and second elongate side portions are longer than the first and second shortened side portions.

Preferably, the sealing means comprises four substantially straight side portions.

Preferably, each side portion is joined to a neighbouring side portion by a corner section.

Preferably, the sealing means comprises two elongate side portions and two shortened side portions.

Preferably, the sealing means has an undeformed state.

Preferably, in the undeformed state the cross-sectional width of the central portion is less than 10 mm.

Preferably, in the undeformed state the cross-sectional width of the central portion is 2.8 mm.

Preferably, in the undeformed state the cross-sectional width of each retainable portion is less than 10 mm.

Preferably, in the undeformed state the cross-sectional width of each retainable portion is 1.8 mm.

Preferably, in the undeformed state the cross-sectional height of the sealing means is 18 mm.

Preferably, the sealing means has a deformed state.

Ideally, the sealing means enters the deformed state when it is located within and squeezed between two channels of neighbouring fluid delivery means.

Preferably, in the deformed state the cross-sectional width of the central portion is greater than 2.8 mm.

Preferably, in the deformed state the cross-sectional width of the central portion is 4.4 mm.

Preferably, in the deformed state the cross-sectional width of each retainable portion is 1.8 mm.

Preferably, in the deformed state the cross-sectional height of the sealing means is less than 18 mm.

Preferably, in the deformed state the cross-sectional height of the sealing means is 14.4 mm.

Preferably, in the deformed state the central portion has an increased cross-sectional width. Advantageously, the increased width of the central portion in the deformed state allows the sealing member to accommodate any slight differences in size/dimensions of the respective channels/flanges of the fluid delivery means between which the sealing member is retained.

Preferably, the width of the central portion in the deformed state is greater than the width of the central portion in the undeformed state.

Preferably, the width of the retainable portions in the deformed stated is substantially the same as the width of the retainable portions in the undeformed state.

According to a further aspect of the invention there is provided a retaining means for a sealing means, wherein the retaining means comprises at least one channel formed in at least one receiving body, wherein the at least one channel is adapted to receive and retain the sealing means.

Preferably, the retaining means comprises at least one channel formed in at least one receiving body, wherein the at least one channel is adapted to receive and retain the sealing means.

Preferably, the channel has a predetermined depth.

Preferably, the channel has a predetermined depth suitable for receiving at least a part of the sealing means.

Preferably, the channel has a predetermined depth suitable for receiving a retainable portion of the sealing means.

Preferably, the receiving body comprises a fluid conduit.

Preferably, the receiving body forms at least a part of a battery pack.

Preferably, the receiving body forms part of a battery pack thermal management system.

Preferably, the receiving body is a fluid delivery means.

Preferably, the receiving body is a header tank.

According to a further aspect of the invention there is provided a sealed structure comprising a first retaining means, a second retaining means, and a sealing means.

Preferably, the sealing means is received and retained in the channel of the first retaining means and the channel of the second retaining means.

Preferably, the sealed structure is located within a battery module and/or a battery pack.

Preferably, the sealed structure is formed by two fluid delivery means.

Preferably, the sealed structure is formed by two primary conduits.

Preferably, the fluid delivery means comprises a main chamber.

Preferably, the main chamber of the fluid delivery means is adapted to contain and confine a thermal management fluid as it flows through the fluid delivery means.

Ideally, the or each main chamber is in fluid communication with a primary conduit.

Preferably, the or each main chamber is in fluid communication with a distribution conduit.

Preferably, the or each main chamber is in fluid communication with a plurality of distribution conduits.

Preferably, the main chamber is at least partially defined by a main chamber wall.

Preferably, the main chamber is located within a space defined by a main chamber wall.

Preferably, the fluid delivery means comprises at least one perforable region.

Preferably, the fluid delivery means comprises at least one perforable region for providing an alternative fluid path for a thermal management fluid to pass into and/or out of the fluid delivery means.

Preferably, the main chamber wall comprises one or more perforable regions.

Preferably, the main chamber wall comprises two perforable regions.

Ideally, the or each perforable region is configured to provide a further and/or alternative path for fluid into and/or out of the main chamber of the fluid delivery means, as an addition or alternative to the fluid connection means of primary conduit.

Preferably, the or each perforable region is substantially planar.

Preferably, the or each perforable region comprises a peripheral region.

Preferably, the or each perforable region comprises a substantially circular peripheral region.

Preferably, the or each perforable region is surrounded by a reinforcement member.

Preferably, the or each reinforcement member is a tubular section.

Preferably, the or each tubular section has a main or major axis.

Preferably, the or each tubular section has a main or major axis which is substantially perpendicular to the plane of the perforable region.

Preferably, the or each tubular section has a main or major axis which is perpendicular to the main axis of the primary conduit.

Preferably, the main axis of the or each distribution conduit is substantially parallel to the main axes of the or each tubular section.

Preferably, the plane of the or each perforable region is substantially perpendicular to the plane of the inlet and/or outlet of the primary conduit.

Ideally, the or each perforable region is perforable.

Preferably, the or each perforable region has a perforated state.

Preferably, the or each perforable region has an unperforated state.

Preferably, in the unperforated state the perforable region sealably covers the tubular section.

Preferably, in the unperforated state the perforable region prevents fluid passing into and/or out of the main chamber.

Preferably, in the unperforated state the perforable region prevents fluid passing through the tubular section.

Preferably, in the perforated state the perforable region comprises one or more apertures.

Preferably, in the perforated state the perforable region allows fluid to pass into and/or out of the main chamber.

Preferably, in the perforated state the perforable region allows fluid to pass through the tubular section.

Preferably, the or each secondary conduit comprises one or more fluid connectors.

Preferably, the or each fluid connector is attachable to a tubular section.

Preferably, at least one end of the connector is threaded.

Preferably, the fluid delivery means comprises a second configuration in which the or each secondary conduit is used to transport fluid to/from the main chamber.

Ideally, in the second configuration the fluid inlet and fluid outlet of the primary conduit are closed.

Preferably, in the second configuration the fluid inlet and fluid outlet of the primary conduit are closed by one or more closing means.

Preferably, the closing means comprises blanking plates.

Preferably, in the second configuration fluid cannot pass into and/or out of the main chamber via the primary conduit.

Preferably, in the second configuration the perforable regions are perforated.

Preferably, in the second configuration fluid is able to pass into the main chamber via the perforable regions.

Preferably, the or each secondary conduit comprises a fluid inlet and a fluid outlet.

Preferably, the fluid inlet of the or each secondary conduit is located at a first end of the secondary conduit.

Preferably, the fluid inlet of the or each secondary conduit provides a fluid path into the fluid delivery means.

Preferably, the fluid outlet of the or each secondary conduit is located at a second end of the secondary conduit.

Ideally, the fluid outlet of the or each secondary conduit provides a fluid path out of the fluid delivery means.

Ideally, the fluid inlet and/or fluid outlet of the or each secondary conduit is connectable to a source or drain of thermal management fluid.

Preferably, the or each secondary conduit comprises a secondary conduit wall.

Preferably, the or each secondary conduit comprises a main axis.

Preferably, the or each secondary conduit has a regular cross section.

Preferably, the or each secondary conduit has a circular cross section.

Preferably, the main axis of the or each secondary conduit extends along the length of the secondary conduit.

Preferably, the main axis of the or each secondary conduit is substantially parallel to the direction of fluid flow through the secondary conduit from the inlet to the outlet thereof.

Preferably, the or each secondary conduit is in fluid communication with the main chamber.

Ideally, the or each secondary conduit extends in a direction which is substantially perpendicular to the primary conduit.

Ideally, the main axis of the primary conduit is substantially perpendicular to the main axis or axes of the or each secondary conduits.

Preferably, the or each fluid delivery means comprises at least one distribution conduit.

Preferably, the or each fluid delivery means comprises a plurality of distribution conduits adapted to provide a path for fluid out of and/or into the fluid delivery means, and into and/or out of the thermal management ducts.

Preferably, the or each distribution conduit is in fluid communication with the primary conduit via a main chamber.

Preferably, the fluid delivery means comprises a plurality of distribution conduits.

Preferably, the or each distribution conduit comprises a body.

Preferably, the or each distribution conduit is attached to the wall of the main chamber.

Preferably, the rear member of the fluid delivery means comprises a plurality of aligned distribution apertures.

Preferably, the rear member of the fluid delivery means comprises a plurality of aligned distribution apertures through which fluid can flow between the main chamber and the distribution conduits.

Ideally, the fluid delivery means comprises eight distribution apertures.

Ideally, the fluid delivery means comprises eight distribution conduits.

Ideally, the or each distribution conduit is adapted to allow fluid to pass through said distribution conduit and into and or out of a respective duct.

Preferably, the or each distribution conduit comprises a fluid inlet.

Preferably, the or each distribution conduit comprises a fluid outlet.

Preferably, in use, each fluid inlet and fluid outlet is in fluid communication with the main chamber of the fluid delivery means.

Preferably, the or each distribution conduit comprises an attachment portion.

Preferably, the or each distribution conduit comprises a weldable attachment portion.

Preferably, the or each attachment portion is attachable to the wall of the main chamber.

Preferably, the or each distribution conduit is attached to a thermal management duct.

Preferably, the or each distribution conduit is attached to a thermal management duct in a fluid-tight manner.

Preferably, the or each distribution conduit is attached to a thermal management duct via welding.

Preferably, the or each distribution conduit comprises a duct attachment portion.

Preferably, the or each duct attachment portion is sealably attachable to a duct.

Preferably, the or each duct attachment portion is attachable to a duct via welding.

Ideally, the or each attachment portion comprises one or more fins.

Ideally, the or each attachment portion comprises a plurality of fins which can be welded to a duct at an open end of the duct to provide a fluid seal thereto.

According to a further aspect of the invention there is provided a spacing means adapted to provide a free volume within a battery module.

According to a further aspect of the invention there is provided a battery module comprising a spacing means.

Preferably, the battery module comprises one or more spacing means.

Preferably, the or each spacing means is mechanically coupled to a fluid delivery means.

Preferably, the or each spacing means is adapted to provide a free volume within a battery module. Advantageously, the free volume allows components such as an electrical carrier to be located and easily accessed within the battery module, and ensures that there is a spacing between the fluid delivery means and other components in the battery module, particularly the cells.

Ideally, the spacing means is a tray.

Preferably, the spacing means is adapted to support cells in the cell battery module.

Preferably, the spacing means comprises a plurality of recesses.

Preferably, the spacing means comprises a plurality of recesses which are sized to accommodate a cell.

Preferably, one or more sensing means are attached to the spacing means.

Advantageously, the spacing means can be used to retain a sensor e.g. a temperature sensor in position against a cell wall.

Preferably, at least one sensing means is located in at least one recess.

Ideally, at least one sensing means is located adjacent to a cell in at least one recess.

According to a further aspect of the invention there is provided a battery module comprising at least one busbar.

According to a further aspect of the invention there is provided a busbar for a battery module and/or a battery pack, the busbar comprising a cell connection portion and a primary external connection portion, wherein the cell connection portion is disposed at an angle to the primary external connection portion. Advantageously, the construction of the busbar allows electrical contact to be made between one or more cells within a battery pack or module and an external component.

According to a further aspect of the invention there is provided a busbar for a battery module and/or a battery pack, the busbar comprising a planar cell connection portion, a planar primary external connection portion and at least one planar secondary external connection portion, wherein the cell connection portion comprises a plurality of cell connection apertures arranged in a plurality of rows, wherein the cell connection portion is substantially perpendicular to the primary external connection portion and wherein the secondary external connection portion is substantially perpendicular to the cell connection portion and the primary external connection portion. Advantageously, the construction of the busbar allows electrical contact to be made between one or more cells within a battery pack or module and an external component in a plurality of positions and/or orientations.

Preferably, the busbar is used to electrically interconnect one or more cells.

Preferably, the busbar is used to electrically interconnect the battery module terminals.

Preferably, the busbar is a unitary member.

Preferably, the busbar is of unitary construction.

Preferably, the busbar is formed from an electrically-conductive material.

Preferably, the busbar is formed from aluminium or steel.

Preferably, the busbar is formed from a single sheet of metal.

Preferably, the busbar is formed of a single metallic sheet, such as an aluminum or steel sheet.

Preferably, the busbar is formed of sheet metal which has been formed into a predetermined shape.

Preferably, the battery module comprises at least one busbar.

Preferably, the battery module comprises two or more busbars.

Preferably, the busbar is generally non-planar.

Preferably, the busbar is cut or pressed from sheet metal and bent into a desired final shape.

Preferably, the busbar comprises a body.

Preferably, the busbar comprises a body being made up of a plurality of portions.

Preferably, the busbar comprises a body being made up of a plurality of perpendicular portions.

Ideally, the busbar may be employed in a battery module and/or battery pack to provide electrical connections to the cells within a battery pack and/or battery module.

Preferably, the busbar is a terminal of a battery module.

Preferably, the busbar is a positive or negative terminal of a battery module.

Ideally, the busbar is adapted to receive the edge of an array of cells.

Preferably, the busbar comprises a cell connection portion.

Preferably, the busbar comprises a cell connection portion adapted for electrical connection to the terminals of one or more cells, for example via wire bonding.

Preferably, the cell connection portion is substantially perpendicular to the primary external connection portion.

Preferably, the cell connection portion is adapted to be connectable to the terminals and/or casings of one or more cells.

Preferably, the cell connection portion is generally planar.

Ideally, the cell connection portion comprises one or more cell connection apertures.

Ideally, the cell connection portion comprises a plurality of cell connection apertures.

Preferably, the cell connection portion comprises at least two rows of cell connection apertures.

Preferably, the or each connection aperture is generally rectangular.

Preferably, the or each connection aperture is adapted to allow a wire bond to pass fully therethrough.

Preferably, the or each connection aperture is arranged in a close-packed hexagonal or honeycomb pattern.

Preferably, the busbar comprises one or more fixing apertures. Advantageously, the or each fixing aperture allows the busbar to be fixed in position within a battery module and/or battery pack.

Preferably, the or each fixing aperture is located in the cell connection portion of the busbar.

Preferably, the busbar comprises at least one primary external connection portion.

Preferably, the primary external connection portion is a terminal portion adapted for connection to an external load.

Preferably, the primary external connection portion is adapted for providing electrical connection to a further component such as a further busbar, a terminal, an interconnect or an external load.

Preferably, the cell connection portion is substantially perpendicular to the primary external connection portion.

Preferably, the primary external connection portion comprises a main plane portion.

Preferably, the main plane portion is generally planar.

Preferably, the primary external connection portion comprises one or more raised portions.

Ideally, the primary external connection portion comprises a plurality of raised portions.

Ideally, the primary external connection portion comprises four raised portions.

Preferably, the generally planar portion comprises one or more raised portions.

Preferably, the or each raised portion is adapted for providing electrical connection to a further component such as a further busbar, a terminal, an interconnect or an external load.

Preferably, the or each raised portion is generally planar.

Preferably, the or each raised portion is raised above the main plane of the primary external connection portion.

Preferably, the or each raised portion is adapted to be accessible through the housing of a battery module.

Preferably, the or each raised portion is adapted to pass through an aperture in the housing of a battery module.

Preferably, the or each raised portion is integrally formed in the primary external connection portion.

Preferably, the or each raised portion is formed via pressing.

Ideally, the or each raised portion comprises a planar portion surrounded by a curved peripheral portion.

Preferably, the or each raised portion comprises a retaining means.

Preferably, the or each retaining means comprises a threaded hole.

Preferably, the or each retaining means is adapted to retain a fixing means such as a bolt. Advantageously, the presence of a retaining means allows e.g. an intermodule busbar to be rigidly attached to the connection surface of the busbar.

Preferably, the busbar comprises at least one secondary external connection portion.

Preferably, the busbar comprises a plurality of secondary external connection portions.

Preferably, the busbar comprises two secondary external connection portions.

Preferably, the or each secondary external connection portion is adapted for providing electrical connection to a further component such as a further busbar, a terminal, an interconnect or an external load.

Preferably, the or each secondary external connection portion is substantially planar.

Preferably, the or each secondary external connection portion is located at an end of the primary external connection portion.

Preferably, the busbar comprises at least one retaining means for a fixing means.

Preferably, the at least one retaining means is located in the cell connection portion.

Preferably, at least one retaining means is located in the primary external connection portion and/or the secondary external connection portion.

Preferably, the or each retaining means comprises at least one aperture.

Preferably, the or each retaining means comprises at least one threaded hole.

Preferably, the or each retaining means is adapted to retain a fixing means such as a bolt. Advantageously, the presence of a retaining means allows e.g. a C-shaped intermodule busbar to be rigidly attached to the connection surface of the busbar.

Preferably, the or each secondary electrical connection portion is substantially perpendicular to the primary external connection portion.

Preferably, the or each secondary electrical connection portion is substantially perpendicular to the cell connection portion.

Preferably, the or each secondary external connection portion is substantially perpendicular to the cell connection portion and the primary external connection portion.

Preferably, the primary and secondary electrical connection portions are accessible from the exterior of the battery module. Advantageously the accessibility of primary and secondary electrical connection portions allows the battery module to be electrically connected to other components in a plurality of locations and/or orientations.

Preferably, the or each cell in the battery module is electrically connected to at least one busbar.

Preferably, the or each cell in the battery module is electrically connected to at least one busbar via one or more wire bonds.

Preferably, the or each cell in the battery module is electrically connected to at least one busbar via wire bonds which are fusible and/or frangible electrical connections.

Preferably, the or each wire bond electrical connection to a busbar is made using ultrasonic bonding, laser welding, ultrasonic welding or resistance welding.

Preferably, the or each wire bond is an aluminium wire bond.

Preferably, the busbar is a terminal of the battery module.

Preferably, the busbar is a positive or negative terminal of the battery module.

Preferably, the battery module comprises a housing and the primary external connection portion of the busbar is accessible through a side wall of the housing.

Preferably, the primary external connection portion of the busbar comprises a raised portion and wherein the raised portion passes through the side wall of the housing.

Preferably, the busbar comprises at least one secondary external connection portion and wherein the primary and secondary electrical connection portions are accessible from the exterior of the battery module.

Preferably, the battery module comprises one or more further busbars.

Preferably, the busbar is adapted to provide structural integrity to the battery module.

Preferably, the or each battery module comprises at least one interconnection busbar.

Preferably, the or each battery module comprises a plurality of interconnection busbars.

Ideally, the or each interconnection busbar is generally planar.

Preferably, the or each interconnection busbar is cut or pressed from sheet metal.

Preferably, the or each interconnection busbar comprises a body.

Preferably, the or each interconnection busbar comprises one or more edge portions.

Preferably, the or each edge portion comprises one or more recesses.

Preferably, the or each recess provides a gap through which potting material can be inserted into the battery module.

Preferably, the or each interconnection busbar comprises ore or more potting apertures.

Preferably, the or each interconnection busbar comprises one or more potting apertures in the body separated from an edge portion.

Preferably, the or each interconnection busbar comprises a planar cell connection portion.

Preferably, the or each interconnection busbar comprises a planar cell connection portion adapted to be connectable to the terminals/casings of one or more cells via wire bonds.

Preferably, the or each interconnection busbar comprises one or more fixing apertures. Advantageously, the provision of fixing apertures allows the busbar to be fixed in position within the battery module.

According to another aspect of the invention there is provided a battery module comprising one or more cell arrangement means.

According to a further aspect of the invention there is provided a cell arrangement means for supporting and locating a plurality of cells within a battery module or battery pack, the cell arrangement means comprising: a substantially planar body; a plurality of receiving means formed in the planar body, wherein each receiving means is adapted for receiving and locating a cell. Advantageously, the cell arrangement means allows a group of cells to be securely held in an appropriate arrangement, such as a regular array.

Preferably, the or each battery module comprises at least one cell arrangement means.

Preferably, the cell arrangement means is a plate.

Ideally, the cell arrangement means is for supporting and locating a plurality of cells.

Preferably, the cell arrangement means is for supporting and locating a plurality of cells in an array.

Preferably, the cell arrangement means comprises a substantially planar body.

Ideally, the cell arrangement means comprises one or more receiving formations.

Preferably, the cell arrangement means comprises a plurality of receiving formations, ideally, the or each receiving formation is formed in the body.

Preferably, the or each receiving formation is adapted for receiving and locating an end of a cell.

Preferably, the receiving formations are arranged in a close-packed hexagonal or honeycomb pattern.

Preferably, the receiving formations are adapted to hold cells in a close-packed hexagonal or honeycomb pattern within the battery module.

Preferably, the or each receiving formation comprises a through hole portion.

Preferably, the or each receiving formation comprises a rim portion.

Preferably, the or each rim portion is formed by a stopped hole.

Preferably, the or each rim portion is formed by a stopped hole which passes part of the way through the body of the member.

Preferably, the or each rim portion is circular.

Preferably, the or each rim portion has the same centre as the through hole portion.

Preferably, the or each rim portion has a larger radius than the through hole portion.

Preferably, an end of the or each cell rests against a rim portion.

Ideally, the or each rim portion prevents the cell from passing through the body of the member.

Preferably, the or each through hole portion passes completely through the body.

Preferably, the or each through hole portion provides a path through which a wire bond can pass.

Preferably, the cell arrangement means comprises two straight edges.

Preferably, the cell arrangement means comprises two curved edges.

Preferably, the curved edges are on opposing sides on the body.

Preferably, the curved edges are joined by straight edges.

Ideally, the curved edges are formed in a repeating pattern of protrusions and recesses.

Ideally, each protrusion on the first curved edge is directly opposite a recess on the second curved edge.

Preferably, the curved edges are formed such that the first curved edge of a first cell arrangement means fits into the second curved edge a of a second cell arrangement member, and vice versa.

Preferably, the curved edges are formed such that the first curved edge of a first cell arrangement means fits into the second curved edge a of a second cell arrangement member, and vice versa, while the straight edges of the neighbouring cell arrangement means are substantially aligned.

Preferably, the cell arrangement means comprises a multiple of six receiving formations.

Preferably, the cell arrangement means is six receiving formations wide.

Preferably, in use the or each cell arrangement means is located between the end of a plurality of cells and a cell connection portion, of a busbar.

Preferably, the cell arrangement means is electrically insulating.

Preferably, the cell arrangement means electrically insulates the busbars from the array of cells.

Preferably, the battery module comprises a plurality of cell arrangement means.

Preferably, the or each cell is held within the battery module between two cell arrangement means.

Preferably, the cell arrangement means is located between one or more cells and a busbar.

According to another aspect of the invention there is provided a battery pack comprising, one or more battery modules; a battery pack management means for monitoring and/or controlling the operation of the battery pack; a battery pack fluid connection means for connecting the battery pack to a source of thermal management fluid; and a battery pack electrical connection means for electrically connecting the battery pack to an external load. Advantageously, the battery pack can be adapted to suit a particular set of design requirements by adjusting the number, locations and/or orientations of battery modules within the battery pack.

Ideally, the battery pack comprises a battery pack housing.

Preferably, the battery pack housing comprises a lowercase member.

Preferably, the battery pack housing comprises a cover member.

Preferably, the battery pack housing comprises an end enclosure.

Preferably, the lower case member comprises one or more apertures.

Preferably, the lower case member comprises a cavity.

Preferably, the lower case member comprises a cavity for receiving one or more battery modules.

Preferably, the lower case member comprises a cavity for receiving a plurality of battery modules.

Preferably, the lower case member comprises a cavity for receiving a battery module sub assembly.

Preferably, the cover member is adapted to cover an aperture in the lower case member.

Ideally, the battery pack housing comprises two side walls.

Preferably the battery pack comprises two end walls.

Preferably the battery pack comprises a base wall.

Preferably the battery pack comprises a top wall.

Preferably the battery pack comprises an end enclosure.

Preferably, the end enclosure is attachable to an end wall of the battery pack.

Preferably, the battery pack is locatable within a predetermined volume.

Preferably, the battery pack is locatable within a predetermined volume within an apparatus such as a mobile apparatus or an industrial apparatus.

Preferably, the battery pack is locatable within a predetermined volume in a road-going vehicle such as a car, truck, lorry, road sweeper, tractor or digger.

Preferably, the battery pack is locatable within a predetermined volume in an industrial apparatus such as a plant.

Preferably, the battery pack is adapted to fit within a predetermined volume originally designed to accommodate an alternative power source such as a diesel engine.

Ideally, the battery pack comprises a battery pack management means.

Ideally, the battery pack comprises a battery pack management means for monitoring and/or controlling the operation of the battery pack.

Preferably, the battery pack comprises a battery pack fluid connection means.

Preferably, the battery pack fluid connection means comprises a battery pack fluid inlet and a battery pack fluid outlet.

Preferably, the thermal management means of the or each battery module in the battery pack are in fluid communication with the battery pack fluid connection means.

Preferably, the battery pack comprises a battery pack fluid connection means for connecting the battery pack to a source of thermal management fluid.

Preferably, the inlet-side fluid delivery means of each battery module is in fluid communication with the inlet-side fluid delivery means of at least one other battery module.

Preferably, the outlet-side fluid delivery means of each battery module is in fluid communication with the outlet-side fluid delivery means of at least one other battery module.

Preferably, the battery pack comprises a battery pack fluid connection means for connecting the battery pack to an external source of thermal management fluid.

Preferably, the thermal management fluid is water and/or a water-glycol mixture.

Preferably, the battery pack fluid connection means is adapted to allow the battery pack to be operably connected to a thermal management system.

Preferably, the thermal management system comprises a source of thermal management fluid.

Preferably, the thermal management system comprises a reservoir for containing the thermal management fluid.

Ideally, the thermal management system comprises a heat exchanger and a pump.

Preferably, the thermal management system comprises a coolant loop.

Preferably, the thermal management system comprises a pressure sensor.

Ideally, the pressure sensor is adapted to monitor the pressure in the thermal management system, particularly the coolant loop.

Preferably, the battery pack fluid connection means comprises a battery pack fluid inlet.

Preferably, the battery pack fluid inlet provides a fluid intake means i.e. a path for fluid to enter the battery pack.

Preferably, the battery pack fluid inlet comprises an inlet adapter.

Preferably, the battery pack fluid inlet comprises an inlet conduit.

Preferably, fluid is able to enter the battery pack via the inlet adapter and inlet conduit.

Preferably, fluid is able to enter the battery pack through an aperture in an end wall of the battery pack housing.

Preferably, the battery pack fluid connection means comprises a battery pack fluid outlet.

Preferably, the battery pack fluid outlet provides a fluid exhaust means i.e. a path for fluid to exit the battery pack.

Ideally, the battery pack fluid outlet comprises an outlet adapter.

Preferably, the battery pack fluid outlet comprises an outlet conduit.

Preferably, fluid is able to exit the battery pack via the outlet adapter and outlet conduit.

Preferably, fluid is able to exit the battery pack through an aperture in the end wall of the battery pack housing.

Preferably, the battery pack fluid inlet and the battery pack fluid outlet are in fluid communication with one another.

Ideally, the battery pack fluid inlet and the battery pack fluid outlet are in fluid communication with one another via the or each battery module.

Ideally, the battery pack fluid inlet and the battery pack fluid outlet are in fluid communication with one another via the battery module sub assembly, ideally, the inlet conduit and/or outlet conduit is curved.

Preferably, the inlet conduit comprises a first end and a second end.

Preferably, the outlet conduit comprises a first end and a second end.

Preferably, the first end of the inlet conduit and/or the first end of the outlet conduit is connectable to one or more battery modules.

Preferably, the second end of the inlet conduit and/or the second end of the outlet conduit is substantially flat.

Preferably, the second end of the inlet conduit and/or the second end of the outlet conduit comprises a generally square locating member.

Preferably, the locating member is locatable in a retaining means.

Preferably, the retaining means is located on the inside of the battery pack housing.

Advantageously the locating means can be reliably and accurately located during manufacture of the battery pack.

Preferably, the retaining means is located inside the cavity of the lower case member.

Preferably the retaining means is attachable to an end wall or a side wall of the lower case member.

Ideally, the inlet conduit is operably connected to a main fluid inlet of one or more battery modules.

Preferably, the outlet conduit is operably connected to a main fluid outlet of one or more battery modules.

Preferably, the battery pack comprises an electrical connection means.

Preferably, the battery pack comprises an electrical connection means for electrically connecting the battery pack to an external load.

Preferably, the battery pack electrical connection means is adapted to allow the battery pack to be electrically connected to an external load such as a motor or other electrical component of a vehicle, machine or piece of industrial apparatus.

Preferably, the electrical connection means comprises positive and negative battery pack terminals.

Preferably, the electrical connection means comprises electrical adapters.

Preferably, the positive and negative terminals are provided by electrical adapters.

Preferably, the adapters are located in the end enclosure.

Preferably, the adapters pass through the wall of the end enclosure.

Preferably, the battery pack comprises a busbar.

Preferably, the battery pack comprises a plurality of busbars.

According to a further aspect of the invention there is provided a battery pack comprising a battery module sub assembly.

According to a further aspect of the invention there is provided a battery module sub assembly comprising one or more battery modules. Advantageously, the battery module sub assembly allows a plurality of battery modules to be incorporated into a battery pack and held as a single replaceable unit in a battery pack, ideally, the battery pack comprises a battery module sub assembly.

Ideally, the battery module sub assembly comprises one or more battery modules.

Preferably, the battery module sub assembly comprises a plurality of battery modules.

Preferably, the battery module sub assembly comprises one or more identical battery modules.

Preferably, the battery module sub assembly comprises thirteen identical battery modules.

Preferably, two or more of the battery modules in the battery module sub assembly are fluidly-interconnected.

Preferably, fluid connections are provided between the battery modules in the battery module sub assembly.

Preferably, a coolant fluid is able to flow through the battery module sub assembly.

Preferably, the battery module sub assembly comprises a main fluid inlet.

Preferably, the battery module sub assembly comprises a main fluid outlet.

Preferably, a coolant fluid is able to flow through the battery module sub assembly via the main fluid inlet, the battery modules and the main fluid outlet.

Preferably, at least some or all of the fluid connections between battery modules are parallel fluid connections.

Preferably, fluid is able to flow through each of the battery modules in parallel.

Optionally, at least some or all of the fluid connections are series fluid connections.

Preferably, fluid is able to flow through two or more battery modules successively.

Preferably, two or more of the battery modules in the battery module sub assembly are electrically-interconnected.

Preferably, two or more of the battery modules in the battery module sub assembly are electrically-connected in parallel.

Preferably, two or more of the battery modules in the battery module sub assembly are electrically-connected in series.

Preferably, electrical connections are provided between the battery modules in the battery module sub assembly.

Ideally, electrical current is able to flow through the battery module sub assembly.

Preferably, electrical current is able to flow through the battery module sub assembly via the negative terminal busbar, the battery modules and the positive terminal busbar.

Preferably, the battery modules are connected in series.

Preferably, in use, the battery modules are discharged in series.

Optionally, the battery modules are connected in parallel.

Optionally, in use, the battery modules are discharged in parallel.

Preferably, the positive side of at least one battery module is connectable to a negative side of a neighboring battery module.

Preferably, the battery module sub assembly comprises one or more intermodular busbars.

Preferably, two or more battery modules are connected via intermodule busbars, ideally, the positive side of at least one battery module is connectable to a negative side of a neighboring battery module via one or more intermodule busbars.

Preferably, the or each intermodule busbar is a planar electrically-conductive member.

Preferably, the or each intermodule busbar is adapted to provide an electrical connection between two neighbouring or adjacent battery modules.

Preferably, the battery module sub assembly comprises one or more peripheral battery modules.

Ideally, the battery pack comprises two peripheral battery modules.

Ideally, each peripheral battery module is located at an outer peripheral edge of the battery module sub assembly.

Preferably, the battery module sub assembly comprises terminal busbars.

Preferably, the battery module sub assembly comprises positive and negative terminal busbars.

Preferably, the peripheral battery modules are connectable to the positive and negative battery pack terminals.

Preferably, the peripheral battery modules are connectable to the positive and negative battery pack terminals via positive and negative terminal busbars.

Preferably, the positive terminal of the battery pack is electrically connected to a first peripheral battery module a via a positive terminal busbar.

Preferably, the positive terminal busbar is electrically connected to the positive side of a first peripheral battery module.

Preferably, the negative terminal of the battery pack is electrically connected to a peripheral battery module via a negative terminal busbar.

Preferably, the negative terminal busbar is electrically connected to the negative side of a second peripheral battery module.

Preferably, the battery pack comprises a manual disconnection means.

Ideally, the manual disconnection means is a manual service disconnect.

Ideally, the manual disconnection means comprises a switch.

Preferably, the switch is located within the end enclosure.

Preferably, the switch is operably connected to the central battery modules.

Preferably, the manual disconnection means is configured to electrically disconnect two groups of battery modules within the battery pack.

Preferably, the groups of battery modules comprise the same, or alternative, numbers of battery modules.

Preferably, the manual disconnection means is configured to disable the terminals of the battery pack.

Preferably, activating the manual disconnection means causes electrical disconnection of the first and second groups of battery modules.

Preferably, opening the switch disconnects the first and second groups of battery modules.

Preferably, the manual disconnection means is operably connected to one or more central battery modules.

Preferably, the manual disconnection means is operably connected to one or more central battery modules via disconnection busbars.

Ideally, the battery module sub assembly comprises at least one central battery module.

Preferably, the battery module sub assembly comprises two central battery modules.

Preferably, the central battery modules are connected to the manual disconnection means via disconnection busbars.

Preferably, the battery module sub assembly comprises a support means.

Preferably, the battery module sub assembly comprises a support means for supporting and/or mechanically coupling one or more battery modules.

Preferably, two or more of the battery modules in the battery module sub assembly are mechanically connected to one another.

Ideally, the battery modules in the battery module sub assembly are mechanically coupled to each other via the support means.

Preferably, the support means comprises one or more end face support members.

Preferably, the support means comprises two end face support members located at the peripheral ends of the battery module sub assembly.

Ideally, the support means comprises elongate corner support members.

Ideally, the support means comprises four elongate corner support members.

Preferably, the or each corner support member is an L-shaped section.

Preferably, the or each corner support member is adapted to receive the corners of a plurality of battery modules.

Preferably, the or each elongate corner support member is attachable to the or each battery module.

Preferably, the or each end face support member is an X-frame.

Preferably, the or each end face support member is connected to the or each corner support member.

According to a further aspect of the invention there is provided a battery pack comprising one or more securement means.

According to a further aspect of the invention there is provided a securement means for securing one or more battery modules and/or a battery module sub-assembly within a housing, wherein the securement means restricts movement of at least one battery module and/or the battery module sub-assembly within the housing.

According to a further aspect of the invention there is provided a securement means for securing one or more battery modules and/or a battery module sub-assembly within a housing, the securement means comprising a bearing means operably connectable to at least one battery module and/or a battery module sub-assembly; and a movable pad assembly operably connectable to the bearing means, wherein a force applied to the bearing means causes the movable pad assembly to apply a further force to at least one battery module and/or the battery module sub-assembly, thereby restricting movement of at least one battery module and/or the battery module sub-assembly within the housing. Advantageously, the securement means ensures that a battery module, or collection of battery modules, will not undergo damaging movements within a battery pack housing or other accommodating volume.

Preferably, the battery pack comprises one or more securement means.

Preferably, the battery pack comprises a plurality of securement means.

Ideally, the battery pack comprises eight securement means.

Ideally, the securement means are adapted to secure the battery module sub assembly in place within the battery pack housing.

Preferably, the securement means are adapted to secure the battery module sub assembly in place within the lower case member.

Preferably, the securement means define a separation between the battery pack housing and the battery module sub assembly.

Preferably, the securement means define a separation between the internal surface of the case member and the battery module sub assembly.

Preferably, the or each securement means comprises a bearing element.

Ideally, the or each bearing element is attachable to the battery module sub assembly.

Ideally, the or each bearing element is attachable to the support means.

Preferably, the or each bearing element is attachable to a battery module.

Preferably, the or each bearing element has a unitary construction.

Preferably, the or each bearing element comprises an attachment portion.

Preferably, the or each bearing element comprises a planar attachment portion.

Preferably, the or each bearing element comprises a flange.

Preferably, the or each flange is perpendicular to an attachment portion.

Preferably, the or each flange is rigidly attached to an attachment portion.

Preferably, the or each bearing element is rigidly attached to a battery module sub assembly.

Preferably, the or each bearing element is rigidly attached to a battery module sub assembly such that as the battery module sub assembly moves under the force of gravity, the bearing element moves in the same direction.

Preferably, the or each bearing element is rigidly attached to a battery module sub assembly such that as the battery module sub assembly moves under the force of gravity, the flange moves in the same direction.

Preferably, the bearing element is movable towards the base wall of a battery pack housing.

Ideally, the flange is movable towards the base wall of a battery pack housing.

Ideally, the or each securement means comprises a spring element.

Preferably, the or each spring element is locatable within a channel.

Preferably, the or each spring element is locatable within a channel formed within the outer casing.

Preferably, the spring element comprises a body.

Preferably, the spring element comprises an upper portion, a central portion and a lower portion.

Preferably, the spring element comprises a planar central portion.

Preferably, the upper portion is curved.

Preferably, the upper portion provides a surface on which the flange can rest, in use.

Preferably, the lower portion comprises a ramp section.

Preferably, the ramp section is angled with respect to the central portion.

Preferably, the angle between the central portion and the ramp section is less than 10 degrees.

Preferably, the angle between the central portion and the ramp section is 1-5 degrees.

Preferably, the angle between the central portion and the ramp section is approximately 3 degrees.

Preferably, the or each securement means comprises a movable pad assembly.

Preferably, the movable pad assembly comprises one or more pads.

Preferably, the movable pad assembly comprises an upright pad.

Ideally, the movable pad assembly comprises a base pad.

Ideally, the movable pad assembly comprises a channel section.

Preferably, the or each pad is located and retained within the channel section.

Preferably, the channel section is a resilient member.

Preferably, the channel section is configured to flex, in use.

Preferably, the interior corner of the channel section is flexible. Advantageously, the flexibility of the channel section allows pivotable movement of the upright pad and the base pad.

Preferably, in use the channel section is located at an interior lower corner of the L-shaped outer casing.

Preferably, the movable pad assembly is biased towards a configuration in which the angle between the interior surfaces of the upright pad and the base pad is less than 90 degrees.

Preferably, the or each securement means comprises an outer casing.

Preferably, the outer casing of the securement means is an L-shaped member.

Preferably, the outer casing of the securement means comprises a base member.

Preferably, the outer casing of the securement means comprises an upright member.

Preferably, the outer casing of the securement means comprises a channel.

Preferably, the channel is located in the upright member.

Preferably, in use, the force of gravity acting on the battery module is transferred to the spring element by the bearing element.

Preferably, in use, the bearing element is in contact with, and rests on, the spring element.

Preferably, in use, the flange of the bearing element is in contact with, and rests on, the upper portion of the spring element.

Preferably, the ramp section is locatable between the outer casing of the securement means and the rear surface of the channel section.

Preferably, the ramp section is configured to push against the rear surface of the channel section.

Preferably, in use the ramp section pushes against the rear surface of the channel section.

Ideally, in use the ramp section pushes the upright pad towards the planar portion.

Ideally, in use the upright pad is pushed towards the battery module sub assembly by the weight of the battery module sub assembly.

Preferably, the battery pack comprises a battery pack management means.

Preferably, the battery pack management means is located within the end enclosure.

Preferably, the battery pack management means comprises a battery management computer.

Preferably, the battery management computer is adapted to control the operation of the or each battery module, the battery module sub assembly and/or the battery pack.

Preferably, the battery management computer is a master board.

Preferably, the battery pack management means is operably connectable to a slave board in the or each battery module.

Preferably, the battery pack management means is operably connectable to sensors throughout the battery pack.

Ideally, the battery pack management means is operably connectable to the manual disconnection means.

According to a further aspect of the invention there is provided a method of manufacturing a battery pack, the method comprising locating one or more battery modules in a battery pack housing. Advantageously, the housing provides added protection and a suitable containment means for the battery modules which form the battery pack.

Preferably the method comprises forming a battery module sub-assembly.

Preferably the step of forming the battery module sub-assembly comprises interconnecting two or more battery modules.

Preferably the method comprises providing mechanical, electrical and/or fluid connections between two or more battery modules.

Preferably the method comprises locating the battery module sub-assembly within the battery pack housing.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The invention will now be described with reference to the accompanying drawings which show, by way of example only, embodiments in accordance with the invention.

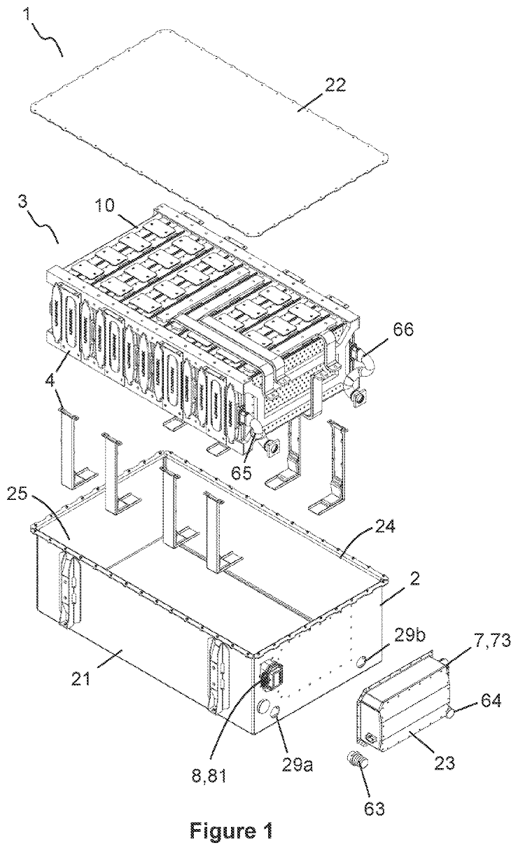

FIG. 1 is an exploded perspective view of a battery pack according to an aspect of the ti invention.

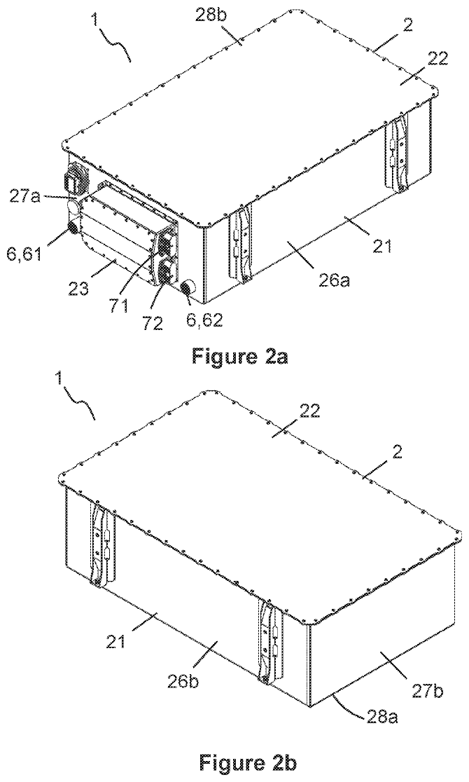

FIG. 2a is a perspective view of a battery pack according to an aspect of the invention.

FIG. 2b is an alternative perspective view of the battery pack of FIG. 2a.

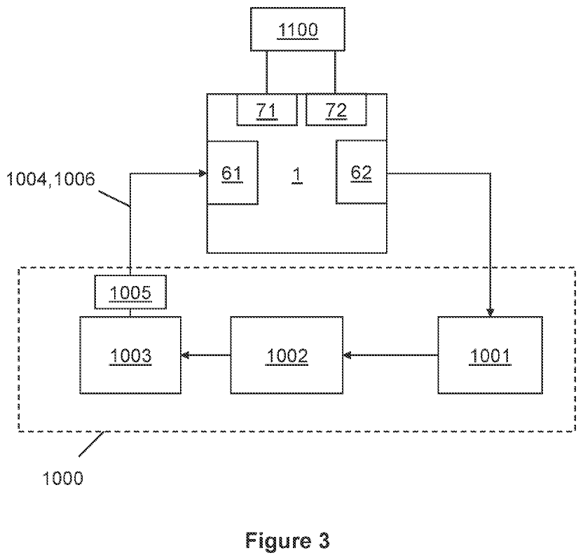

FIG. 3 is a schematic view of a battery pack including a thermal management system.

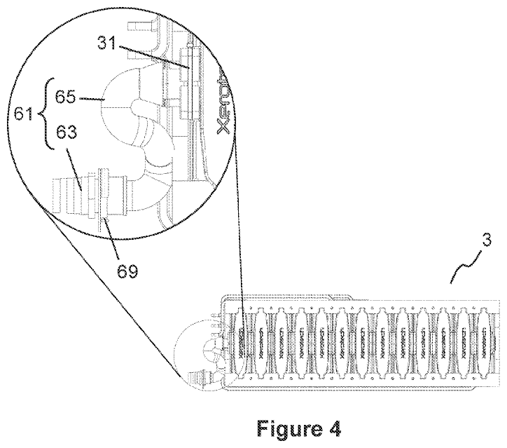

FIG. 4 is a side view and a detailed view of a battery module sub assembly according to an aspect of the invention.

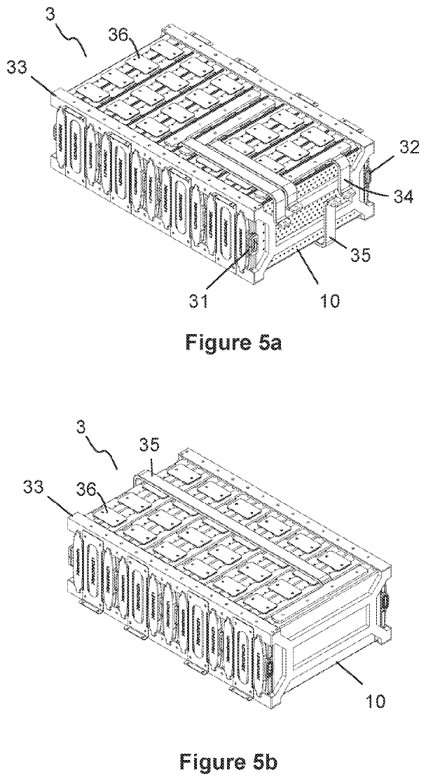

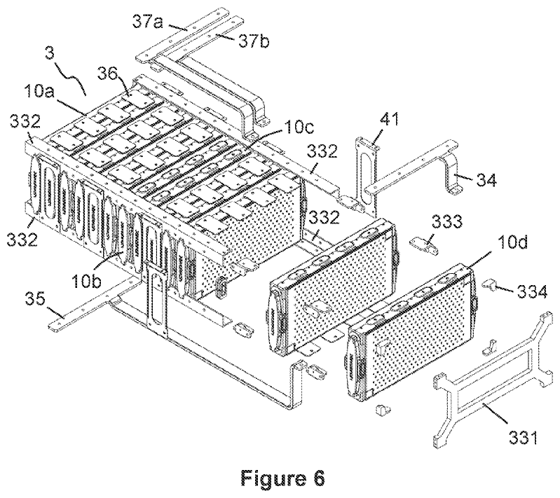

FIG. 5a is a perspective view of a battery module sub assembly according to an aspect of the invention.

FIG. 5b is an alternative perspective view of a battery module sub assembly according to an aspect of the invention.

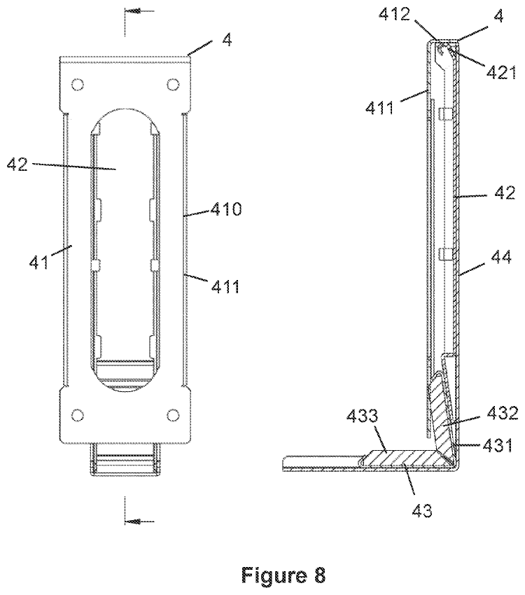

FIG. 8 is an exploded perspective view of a battery module sub assembly according to an aspect of the invention.

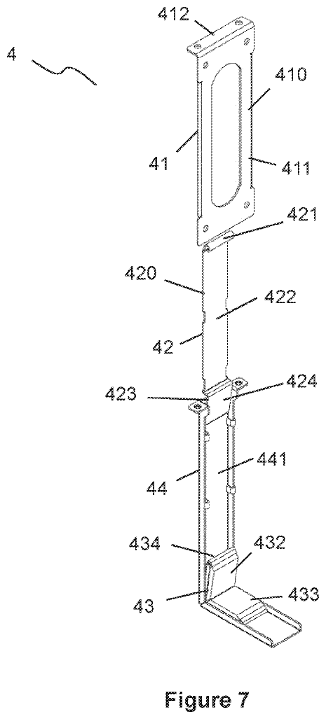

FIG. 7 is a perspective view of a securement arrangement according to an aspect of the invention.

FIG. 8 shows front and side cross-sectional views of a securement arrangement according to an aspect of the invention.

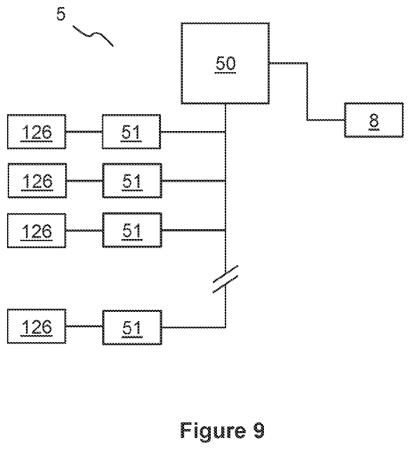

FIG. 9 is a schematic view of a battery pack management system.

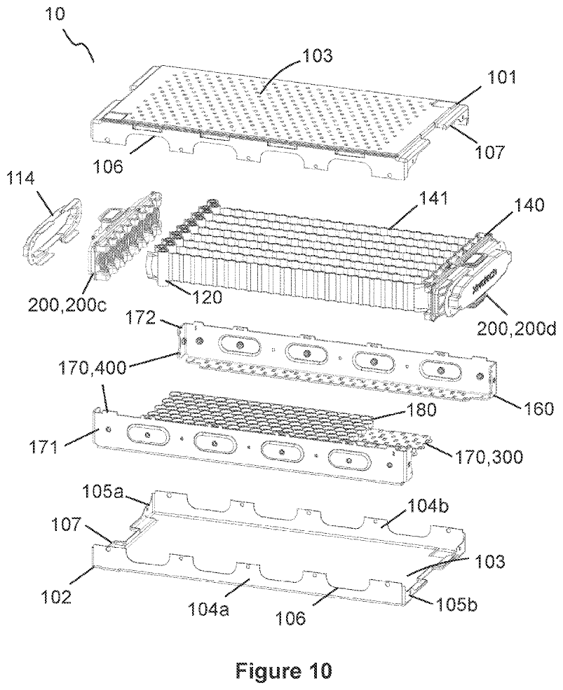

FIG. 10 is an exploded perspective view of a battery module according to an aspect of the invention.

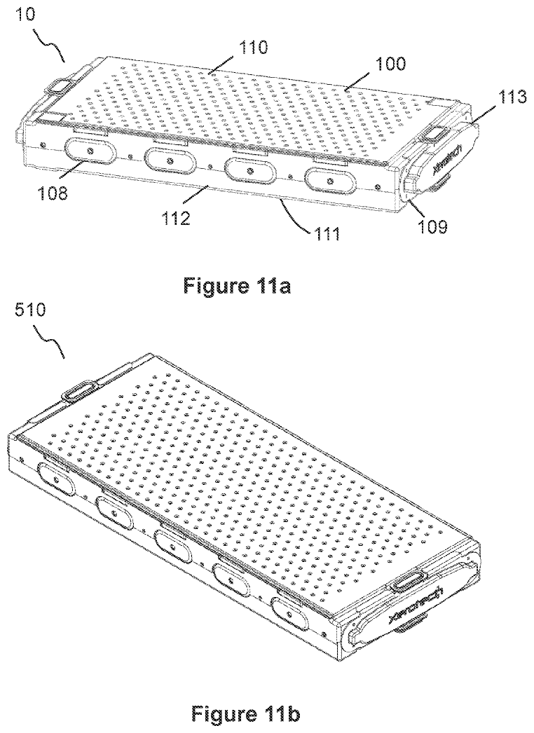

FIG. 11a is a perspective view of a battery module according to an aspect of the invention.

FIG. 11b is a perspective view of an alternative battery module according to an aspect of the invention.

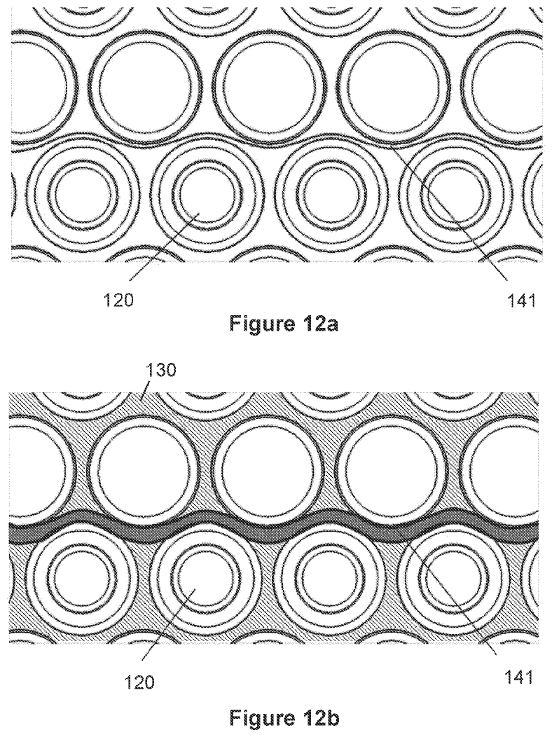

FIG. 12a is a plan view of an arrangement of cells and an uninflated duct.

FIG. 12b is a plan view of an arrangement of cells, an inflated duct and a potting material.

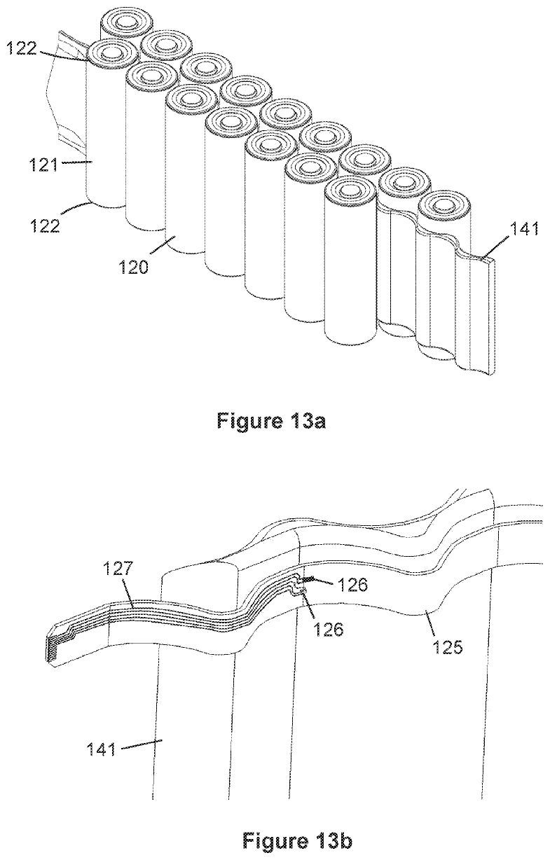

FIG. 13a is a perspective view of two rows of cells and a duct.

FIG. 13b is a perspective view of a duct and a sensor carrier.

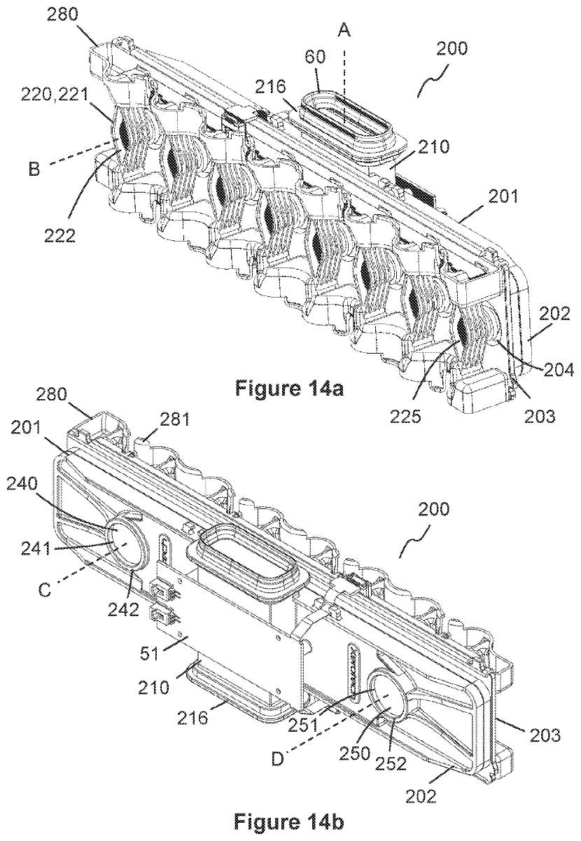

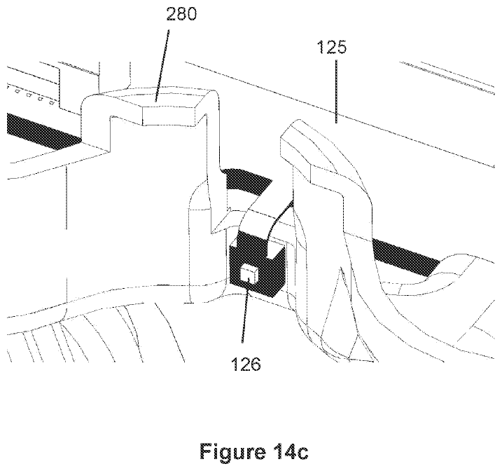

FIG. 14a is a front perspective view of a fluid delivery arrangement according to an aspect of the invention.

FIG. 14b is a rear perspective view of a fluid delivery arrangement according to an aspect of the invention.

FIG. 14c is a detail perspective view of a spacing arrangement.

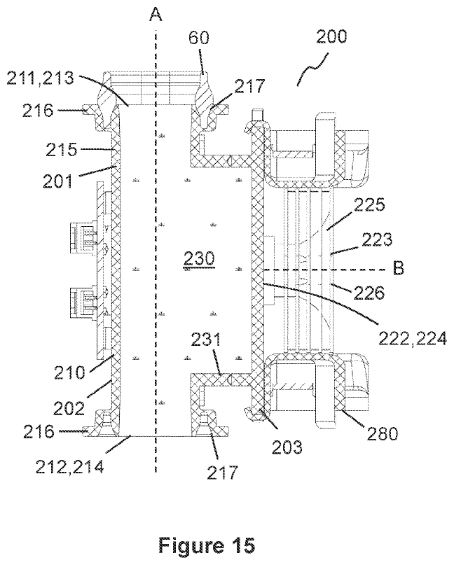

FIG. 15 is a cross sectional view of a fluid delivery arrangement according to an aspect of the invention.

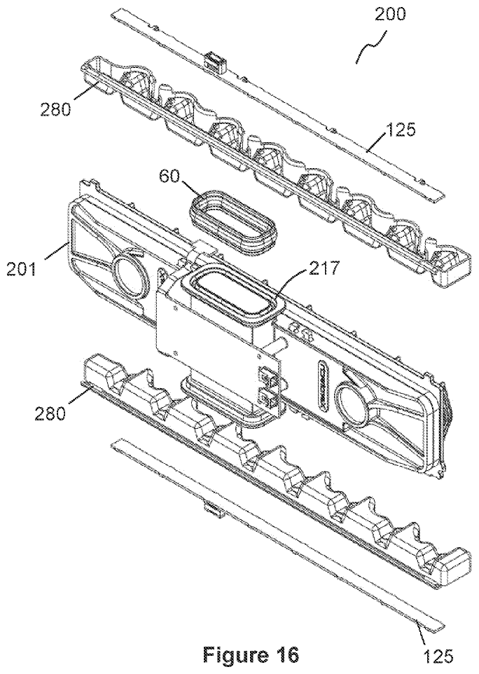

FIG. 16 is an exploded perspective view of a fluid delivery arrangement according to an aspect of the invention.

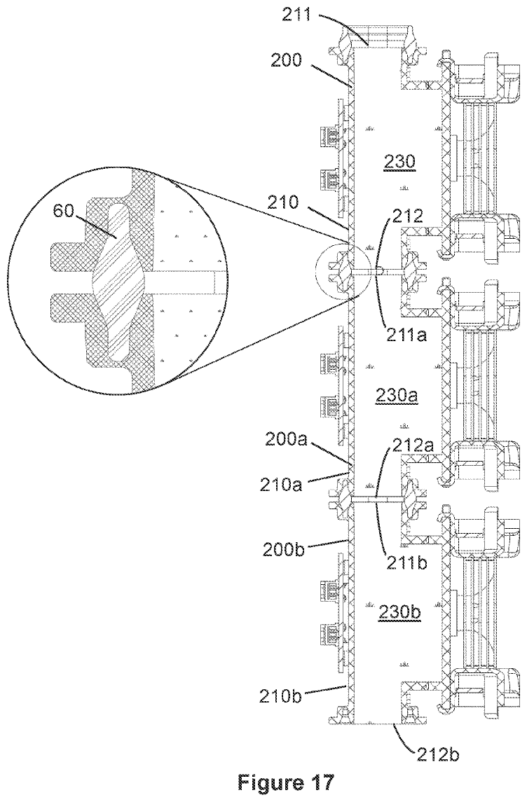

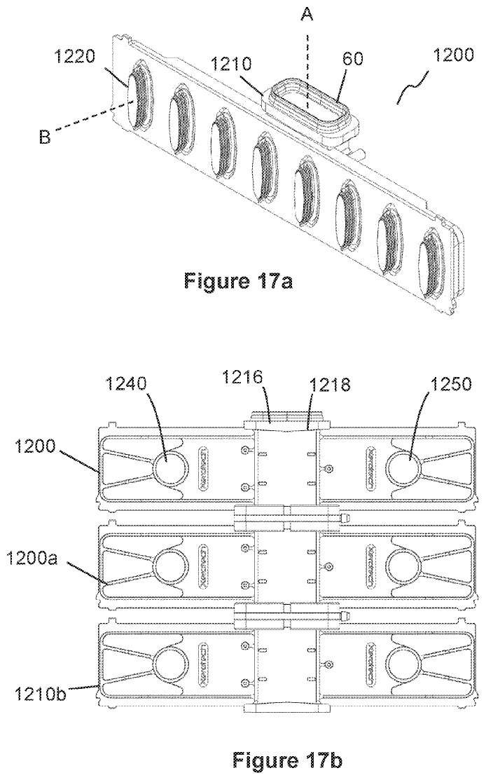

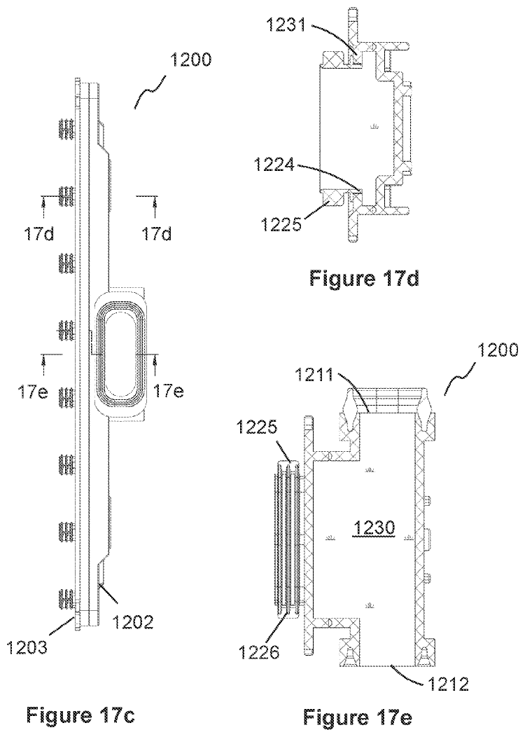

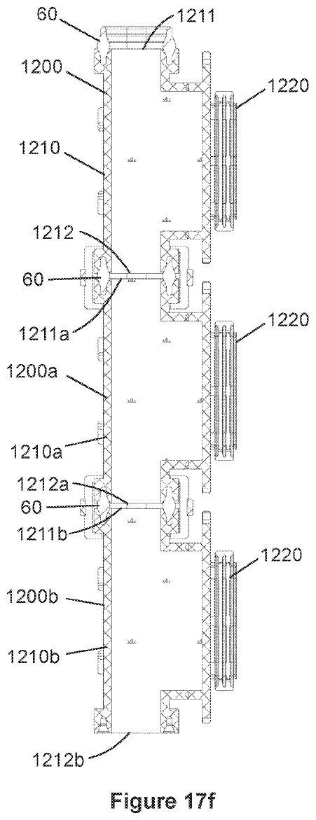

FIG. 17 is a cross sectional view of three interconnected fluid delivery arrangements.

FIG. 17a is a perspective view of a further fluid delivery arrangement according to an aspect of the invention.

FIG. 17b is an end view of three interconnected further fluid delivery arrangements.

FIG. 17c is a top view of the fluid delivery arrangement of FIG. 17a.

FIG. 17d is a cross sectional view through the fluid delivery arrangement of FIG. 17a.

FIG. 17e is a further cross sectional view through the fluid delivery arrangement of FIG. 17a.

FIG. 17f is a cross sectional view through three interconnected further fluid delivery arrangements.

FIG. 189 is a perspective view of a sealing member according to an aspect of the invention.

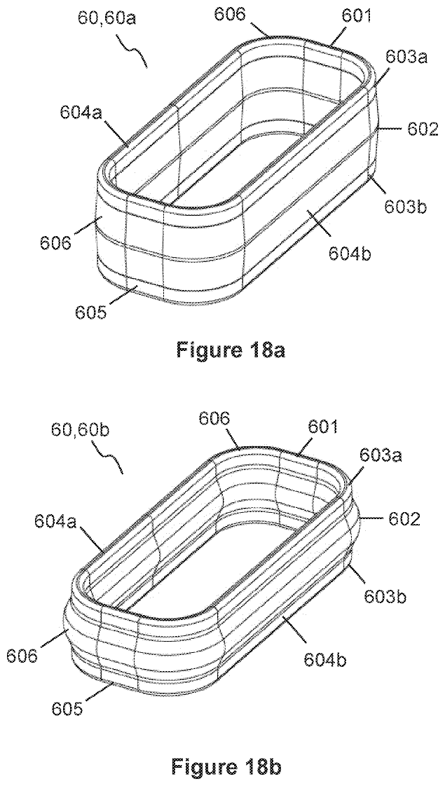

FIG. 18b is a perspective view of a sealing member according to an aspect of the invention.

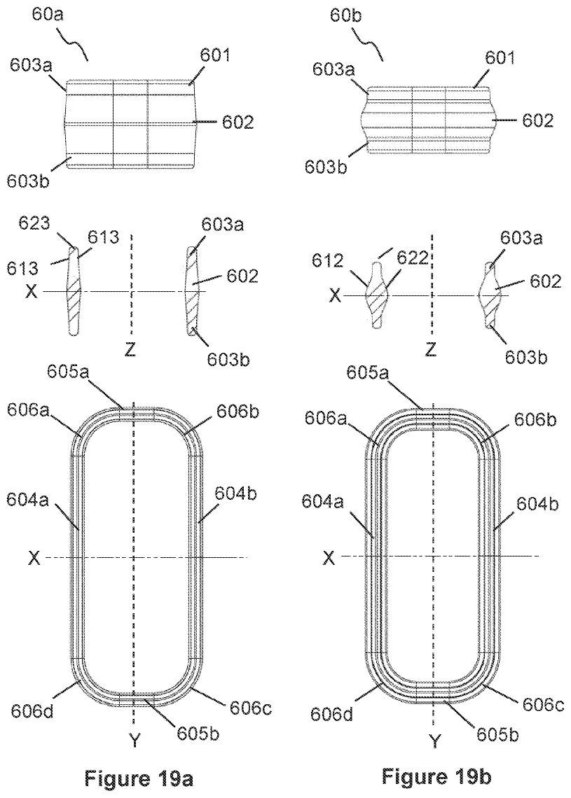

FIG. 19a shows multiple views of a sealing member according to an aspect of the invention.

FIG. 19b shows multiple views of a sealing member according to an aspect of the invention.

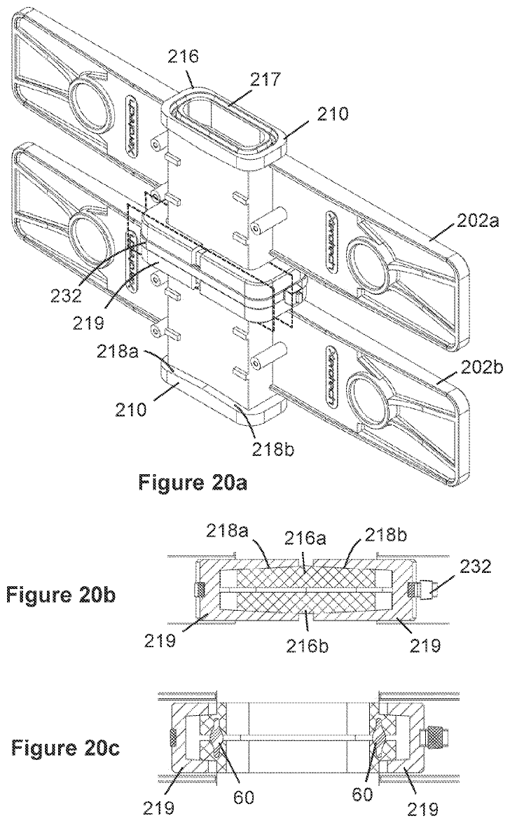

FIG. 20a is a perspective view of two interconnected fluid delivery arrangement sub-components.

FIG. 20b is a cross sectional view of two interconnected primary conduits.

FIG. 20c is a further cross sectional view of two interconnected primary conduits.

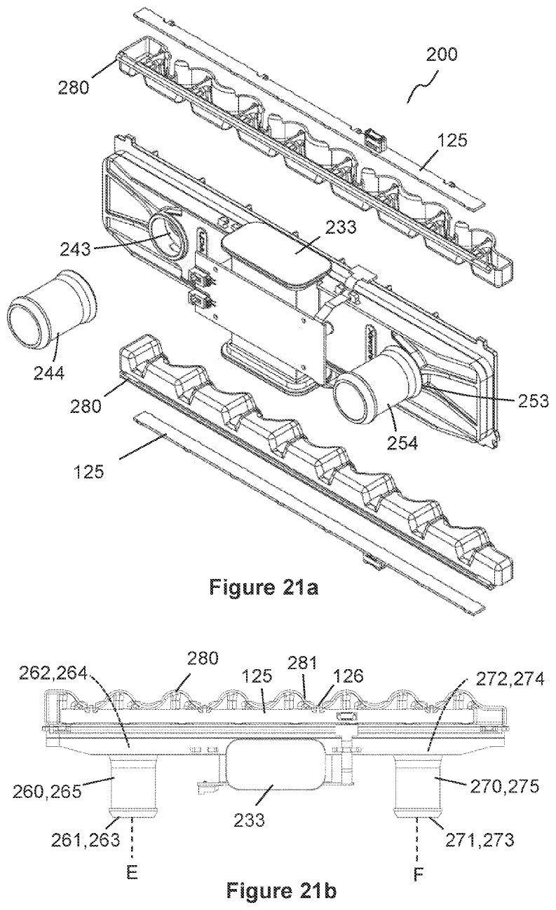

FIG. 21a is an exploded perspective view of a fluid delivery arrangement according to an aspect of the invention.

FIG. 21b is a top view of a fluid delivery arrangement according to an aspect of the invention.

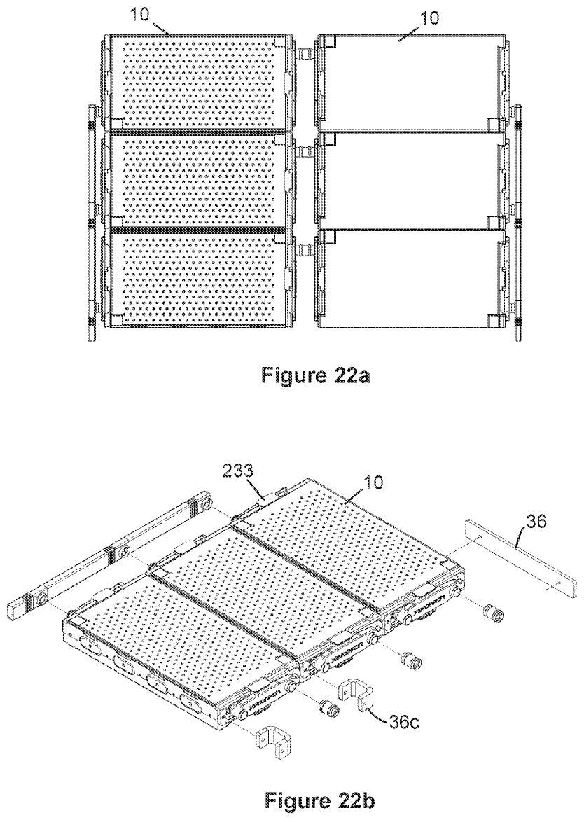

FIG. 22a is a is a top view of interconnected battery modules in a ‘flat pack’ arrangement.

FIG. 22b is an exploded perspective view of interconnected battery modules in a ‘flat pack’ arrangement.

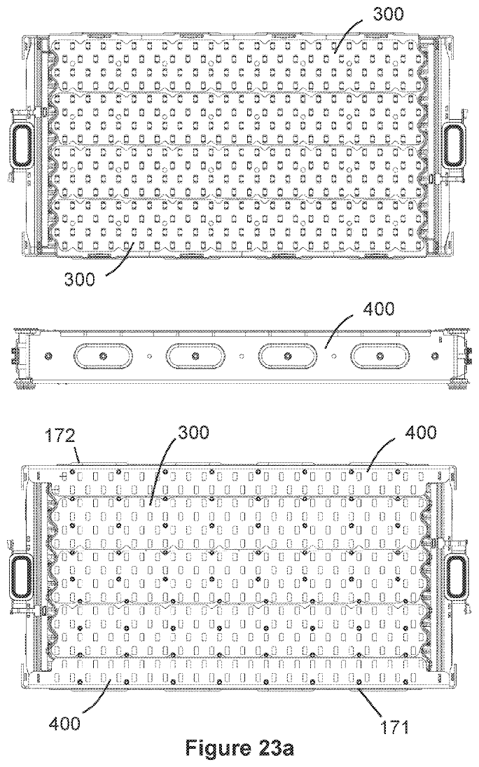

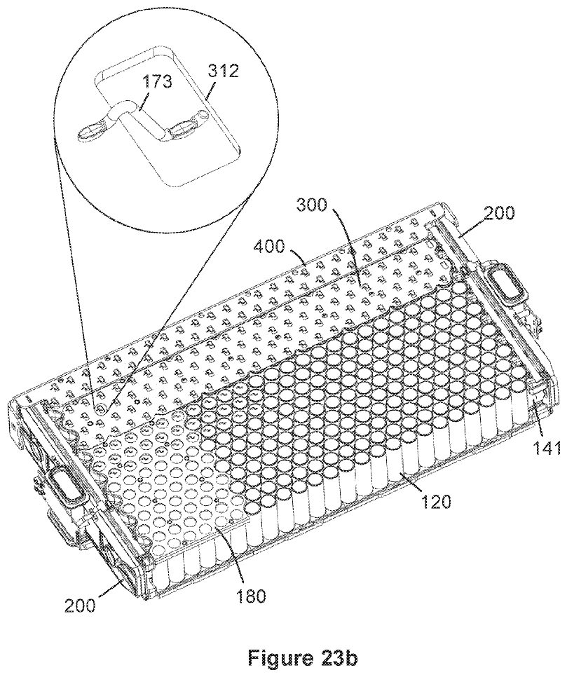

FIG. 23a shows side, top and bottom views of a battery module having the outer housing members removed,

FIG. 23b is a cutaway view showing the internal components of a battery module according to an aspect of the invention.

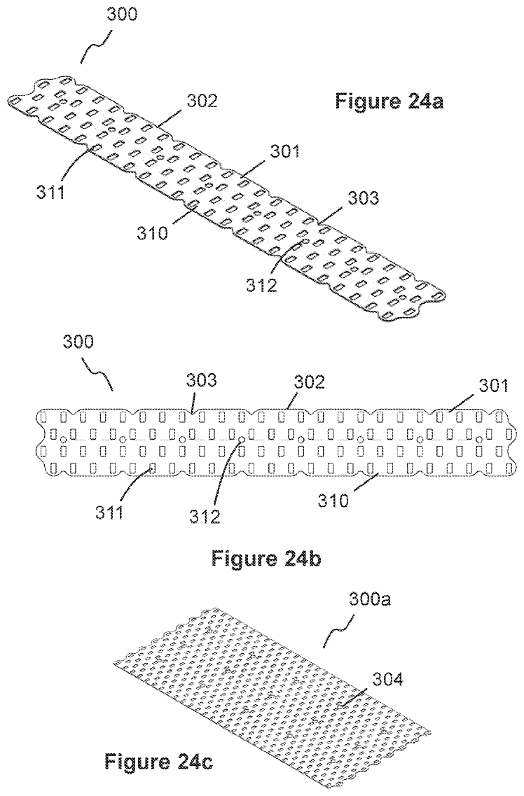

FIG. 24a is a perspective view of a planar busbar.

FIG. 24b is a plan view of a planar busbar.

FIG. 24b is a perspective view of an alternative planar busbar.

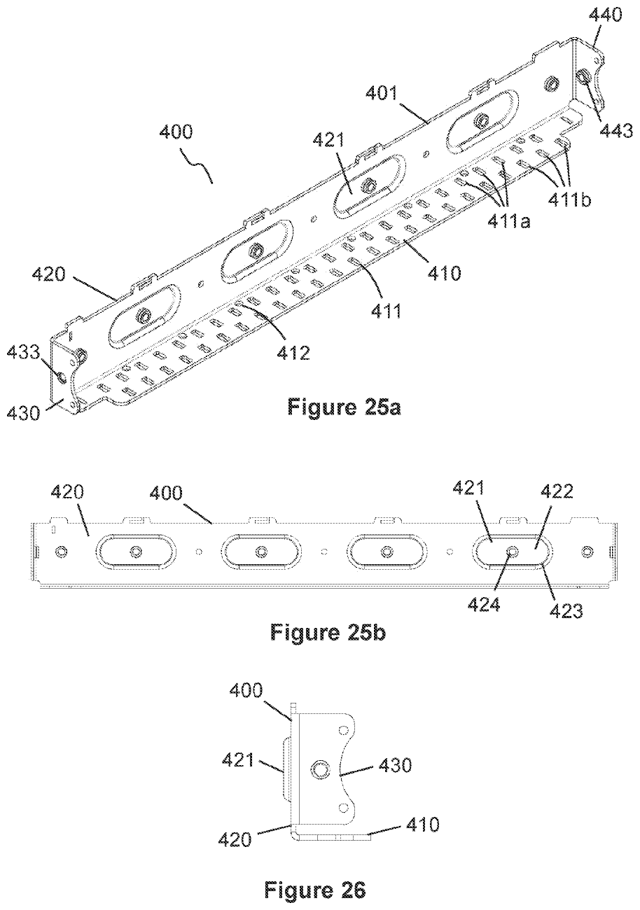

FIG. 25a is a perspective view of a busbar according to an aspect of the invention.

FIG. 25b is a side view of a busbar according to an aspect of the invention.

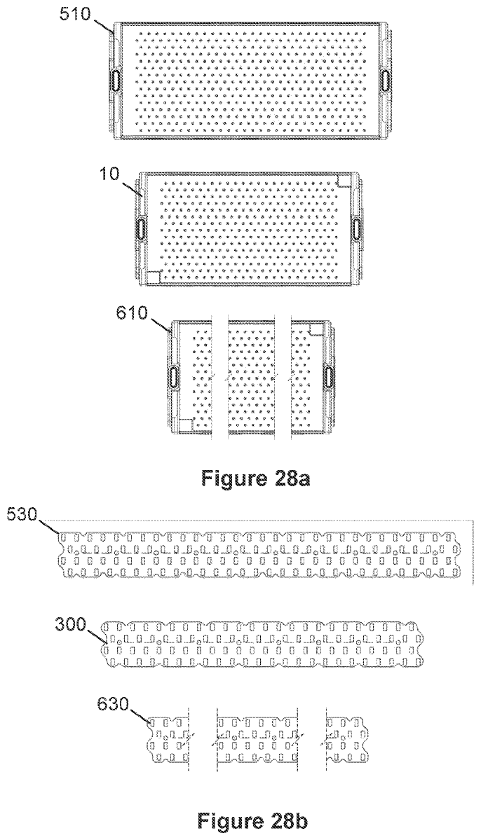

FIG. 28 is an end view of a busbar according to an aspect of the invention.

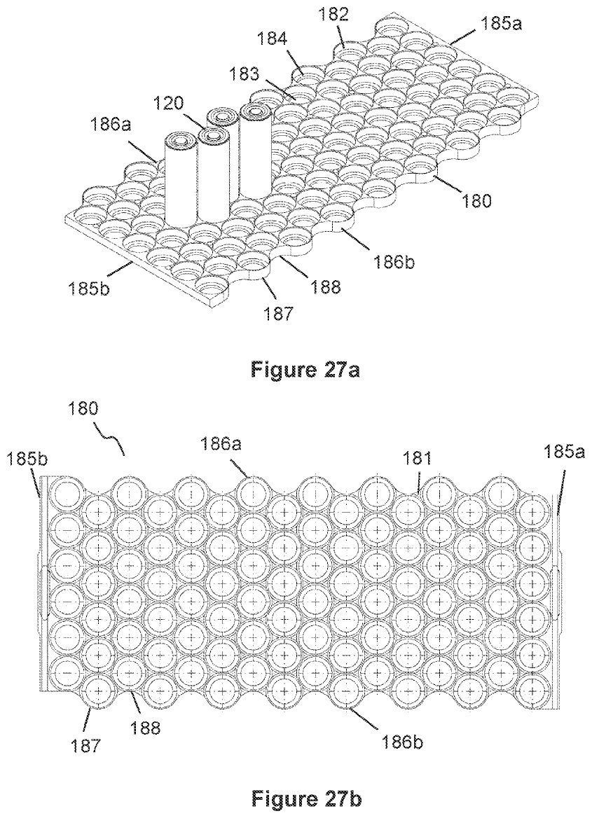

FIG. 27a is a perspective view showing a cell arrangement member and a plurality of cells.

FIG. 27b is a perspective view of a cell arrangement member according to an aspect of the invention.

FIG. 28a shows plan views of several battery modules according to an aspect of the invention.

FIG. 28b shows plan views of several busbars for use in battery modules according to aspects of the invention.

In FIG. 1 there is shown an exploded view of a battery pack 1 according to an aspect of the invention. The battery pack 1 comprises: a battery pack housing 2; a battery module sub assembly 3; a plurality of securement arrangements 4; a battery pack management system 5 for monitoring and/or controlling the operation of the battery pack 1; a battery pack fluid connection arrangement 8 for connecting the battery pack to a source of thermal management fluid; and an electrical connection arrangement 7 for electrically connecting the battery pack 1 to an external load.

The battery pack 1 is locatable within a predetermined volume within an apparatus such as a mobile apparatus or an industrial apparatus. For example, the battery pack 1 is locatable within a volume in a road-going vehicle such as a car, truck, lorry, road sweeper or digger, or an industrial apparatus such as a plant. Where the battery pack 1 is used to convert an existing petroleum-based design into an electrically-powered design, the battery pack 1 can fit within a predetermined volume originally designed to accommodate e.g. a diesel engine.

The battery pack housing 2 comprises a lower case member 21, a cover member 22 and an end enclosure 23. The cover member 22 covers an aperture 24 in the lower case member 21. The lower case member 21 defines a cavity 25 in which the battery module sub assembly 3 is locatable. As shown in FIGS. 2a and 2b the battery pack housing 2 comprises two side walls 28a, 28b, two end walls 27a, 27b, a base wall 28a and a top wall 28b. The end enclosure 23 is attached to an end wall 27a of the battery pack 1.

The battery pack 1 comprises a battery pack electrical connection arrangement 7. The battery pack electrical connection arrangement 7 is adapted to allow the battery pack 1 to be electrically connected to an external load 1100 such as a motor or other electrical component of a vehicle or piece of industrial apparatus. The battery pack electrical connection arrangement 7 comprises positive and negative battery pack terminals 71 and 72. In the embodiment disclosed in FIGS. 1 and 2 the positive and negative battery pack terminals 71, 72 are provided by electrical adapters 73 which pass through the wall of the end enclosure 23.

The battery pack 1 comprises a battery pack fluid connection arrangement 6. The battery pack fluid connection arrangement 6 is adapted to allow the battery pack 1 to be operably connected to a thermal management system 1000 which provides a source of thermal management fluid, preferably water and/or a water-glycol mixture. The thermal management system 1000 shown in FIG. 3 comprises a reservoir 1001 for containing the coolant fluid, a heat exchanger 1002 and a pump 1003 connected to the battery pack 1 in a coolant loop 1004. The reservoir 1001 provides hydrostatic pressure to coolant fluid 1006 in the coolant loop 1004 and the pump 1003 is configured to pump coolant 1006 from the reservoir 1001 to the coolant loop 1004 and to pressurise the coolant loop 1004. A pressure sensor 1005 is used to monitor the pressure of the coolant 1006 such that a target operating pressure is maintained in the coolant loop 1004.

The battery pack fluid connection arrangement 8 comprises a fluid inlet arrangement 61 and a fluid outlet arrangement 62. The fluid inlet arrangement 81 provides a fluid intake i.e. a path for fluid to enter the battery pack 1. The fluid inlet arrangement 61 comprises an inlet adapter 63 and an inlet conduit 65. Fluid 1006 is able to enter the battery pack 1 via the inlet adapter 63 and inlet conduit 65 and through an aperture 29a in an end wall 27a of the battery pack housing 2. The fluid outlet arrangement 62 provides a fluid exhaust i.e. a path for fluid to exit the battery pack 1. The fluid outlet arrangement 62 comprises an outlet adapter 64 and an outlet conduit 66. Fluid 1006 is able to exit the battery pack 1 via the outlet adapter 64 and outlet conduit 66 and through an aperture 29b in the end wall 27a of the battery pack housing 2.

The fluid inlet arrangement 61 and the fluid outlet arrangement. 62 are in fluid communication with one another via the battery module sub assembly 3. As will be appreciated the fluid inlet arrangement 61 and the fluid outlet arrangement 62 are interchangeable in that fluid may pass through these arrangements, and the battery module sub assembly 3 and/or battery modules 10, in either direction as required.

During construction/manufacture of the battery pack 1 and before the battery module sub assembly 3 is located within the battery pack housing 2, the inlet and outlet conduits 65, 66 of the battery pack fluid connection arrangement 6 are operably connected to the main fluid inlet 31 and the main fluid outlet 32 of the battery module sub assembly 3. FIG. 4 shows in detail the connection between the main fluid inlet 31 and the fluid inlet arrangement 61. The main fluid outlet 32 of the battery module sub-assembly 3 is similarly connected to the fluid outlet arrangement 62.

Once the battery module sub assembly 3 is ready to be inserted into the housing 2, the battery module sub assembly 3 is moved into the housing 2 through the aperture 24 and towards the base wall 28a until the inlet and outlet conduits 65, 66 are in alignment with apertures 29a, 29b in the end wall 27a. Once the conduits 65, 66 and apertures 29 are suitably aligned, the inlet and outlet adapters 63, 64 are secured to the conduits 65, 66 and end wall 27a The adapters 63, 64 may be threaded and are tightened until the junction between the components is fluid-tight.

As shown in e.g. FIG. 1, the inlet and outlet conduits 65, 66 of the battery pack fluid connection arrangement 6 are curved to allow the smooth flow of fluid therethrough. First ends of the inlet and outlet conduits 65, 66 are fluidly connected to the battery module sub-assembly 3 via sealing members 80. Second ends of the inlet and outlet conduits are substantially flat and comprise a generally square locating member 69. The locating member 69 is locatable in a retaining means located on the inside of the battery pack housing 2 and the locating member can slide into the retaining member during manufacture. The fact that the ends of the conduits are flat it allows the battery pack to move into the housing 2 more easily. This provides advantages over the prior art solutions in which the conduits must be welded from the inside of the pack and subsequently attached to the battery module sub assembly 3.

FIGS. 5a and 5b provide views of the battery module sub assembly 3. The battery module sub assembly 3 comprises a plurality of identical battery modules 10. In the present example the battery module sub assembly 3 comprises thirteen identical battery modules 10 but as will be appreciated the number and mutual orientation of the battery modules 10 may be varied according to particular design requirements. The battery modules 10 are fluidly- and electrically-interconnected to each other to provide the required electrical and thermal management characteristics required for a particular application. The battery modules 10 are also mechanically coupled to each other via a support arrangement 33.

Fluid connections are provided between the battery modules 10 in the battery module sub assembly 3 such that a thermal management fluid is operable to flow through the battery module sub assembly 3 via the main fluid inlet 31, the battery modules 10 and the main fluid outlet 32. In this example the fluid connections between battery modules 10 are parallel fluid connections i.e. fluid is operable to flow through each of the battery modules 10 in parallel. However, it will be appreciated that in alternative embodiments some or all of the fluid connections may be series fluid connections i.e. fluid may be caused to flow through two or more battery modules 10 successively.

Electrical connections are provided between the battery modules 10 in the battery module sub assembly 3 such that electrical current is operable to flow through the battery module sub assembly 3 via the negative terminal busbar 35, the battery modules 10 and the positive terminal busbar 34. In this example the battery modules 10 are connected in series and, in use, the battery modules 10 are discharged in series. However, it will be appreciated that in alternative embodiments one or more parallel electrical connections may be employed, as necessary.

With the exception of peripheral battery modules 10a, 10d and two central battery modules 10b, 10c, the positive side of each battery module 10 is connected to a negative side of a neighboring battery module 10 via intermodule busbars 36. In this example each intermodule busbar 36 is a planar electrically-conductive member adapted to provide an electrical connection between two neighbouring battery modules 10.

The peripheral battery modules 10a, 10d are connected to the positive and negative battery pack terminals 71, 72 via positive and negative terminal busbars 34, 35. The positive terminal 71 is electrically connected to a first peripheral battery module 10a via a positive terminal busbar 34 and the negative terminal 72 is electrically connected to a second peripheral battery module 10d via a negative terminal busbar 35. The positive terminal busbar 34 is electrically connected to the positive side of a first peripheral battery module 10a, and the negative terminal busbar 35 is electrically connected to the negative side of a second peripheral battery module 10d.

The central battery modules 10b, 10c are connected to a manual disconnection arrangement 8 via disconnection busbars 37a and 37b. The manual disconnection arrangement 8 is a manual service disconnect. The manual disconnection arrangement 8 comprises a switch 81 located within the end enclosure 23. There is a simple link connector built into the manual service disconnect which is monitored by the battery management system. When no connection is found the battery management system will remove power to the main contactors/relays thereby cutting all potential from the rest of the high voltage battery. The manual service disconnect removes any potential, in the event of an accident/impact where there may be potential of other shorts within the battery pack this feature adds another level of safety. The switch 81 is operably connected to the central battery modules 10b, 10c in the battery pack 1 via the disconnection busbars 37a, 37b.

The manual disconnection arrangement 8 is configured to electrically disconnect two groups of battery modules 10 within the battery pack 1, thereby disabling the terminals 71, 72 of the battery pack 1. In this example the first group of battery modules comprises seven battery modules 10a-10b, and the second group of battery modules comprises six battery modules 10c-10d. When the switch 81 is opened the first and second groups of battery modules 10 are disconnected from each other such that no current can flow between them. As will be appreciated the position within the battery module sub assembly 3 where the disconnect 8 operates can be varied such that alternative numbers of battery modules 10 are included in each group.

The battery modules 10 in the battery module sub assembly 3 are mechanically connected and held together by a support arrangement 33. The support arrangement 33 comprises two end face support members 331 located at the peripheral ends of the battery module sub assembly 3. The battery module support arrangement 33 also comprises four elongate corner support members 332. Each corner support member 332 is an L-shaped section which accommodates the corners of a plurality of battery modules 10. Each elongate corner support member 332 is attached to the battery modules 10 via corner attachment members 333 and fasteners such as screws and/or bolts. Each end face support member 331 is an X-frame connected to each corner support member 32a-d via attachment members 333 and end caps 334. Fasteners such as screws and/or bolts are used to attach the components of the support arrangement 33 together.

Returning to FIG. 1 the battery pack 1 comprises eight securement arrangements 4. The securement arrangements 4 are adapted to secure the battery module sub assembly 3 in place within the battery pack housing 2, particularly within the lower case member 21. The securement arrangements 4 define a separation between the battery pack housing 2, particularly the internal surface of the case member 21, and the battery module sub assembly 3. As will be appreciated more or fewer securement arrangements 4 may be employed and they may be located in alternative positions within the housing 2.

FIG. 7 shows an exploded view of a securement arrangement 4 according to an aspect of the invention. The securement arrangement 4 comprises a bearing element 41, a spring element 42, a movable pad assembly 43 and an outer casing 44.

Bearing element 41 is attachable to the battery module sub assembly 3, particularly the support arrangement 30 and/or individual battery modules 10 thereof. Bearing element 41 has a unitary construction comprising a planar attachment portion 411 and a flange 412. The attachment portion is wide enough to be attached to neighbouring elongate corner support members 333 via e.g. screws. The flange 412 is perpendicular to the attachment portion 411. The flange 412 is rigidly attached to the attachment portion 411. The bearing element 41 is rigidly attached to the battery module sub assembly 3 such that as the battery module sub assembly 3 is pulled towards the base wall 28a, the bearing element 41; and particularly the flange 412, moves in the same direction towards the base wall 28a.

As shown in FIG. 8, the spring element 42 is locatable within a channel 441 formed within the outer casing 44. Spring element 42 comprises a body 420 having an upper portion 421, a planar central portion 422 and a lower portion 423. The upper portion 421 is curved to provide a surface on which the flange 412 can rest, in use, and the lower portion 423 comprises a ramp section 424. The ramp section 424 is angled with respect to the central portion, the angle between the central portion and the ramp section 424 being approximately 3 degrees.

The movable pad assembly 43 comprises an upright pad 432 and a base pad 433, both of which are located and retained within a channel section 431. The channel section 431 is a resilient member. The interior corner of the channel section 431 can flex, allowing pivotable movement of the upright pad 432 and the base pad 433. In use the channel section 431 is located at an interior lower corner of the L-shaped outer casing 44. The resilience of the channel section 431 biases the movable pad assembly to a configuration in which the angle between the interior surfaces of the upright pad 432 and the base pad 433 is slightly less than 90 degrees.

In use, the flange 412 of the bearing element 41 is in contact with, and rests on, the curved upper portion 421 of the spring element 42. As the bearing element 41 is attached to the heavy battery module sub assembly 3, the spring element 42 is pushed down through the channel 441 of the outer casing 44 such that the ramp section 424 rests on, and pushes against, the movable pad assembly 43. In particular, the ramp section 424 lies between the outer casing 44 and the rear surface of the channel section 431. The ramp section 424 acts to push against the rear surface of the channel section 431 so that the upright pad 432 is pushed inwards towards the lower section of the planar portion 411. In this way, the upright pad 432 is pushed against the battery module sub assembly 3. In effect, the weight of the battery module sub assembly 3 is used as a retaining force.

As will be appreciated the securement arrangements 4 may be located in the battery pack 1 in any position where the weight of the battery module sub assembly 3 will cause the respective upright pads 432 to move towards and ‘squeeze’ the battery module sub assembly 3. In alternative embodiments the squeezing action will be due to the construction of the pack 1, rather than the force of gravity acting on the sub-assembly 3. For example, spacers on the cover member 22 could be used to push the battery module sub assembly 3 towards the base wall 28a.

FIG. 9 is a schematic view of a battery pack management system 5 which is at least partially located within the end enclosure 23 of the battery pack 1. The battery pack management system 5 comprises a battery management computer 50. The battery management computer 50 is adapted to control the operation of each battery module 10, as well as the operation of the battery pack 1 more generally. The battery management computer 50 is a master board which is operably connected to a slave board 51 in each battery module 10 and sensors throughout the battery pack 1. The battery management computer 50 is operably connected to the manual disconnection arrangement 8, particularly switch 81.

FIG. 10 is an exploded view of a battery module 10 according to an aspect of the invention. The battery module 10 comprises one or more cells 120 (only a subset of which are shown in FIG. 10, for clarity) and a thermal management arrangement 140 for thermally managing the one or more cells 120. The thermal management arrangement 140 comprises at least one thermal management duct 141, and two fluid delivery arrangements 200. Particularly, the thermal management arrangement 140 comprises an intake-side fluid delivery arrangement 200c and an outlet-side fluid delivery arrangement 200d. The inlet-side fluid delivery arrangement m 200c is in fluid communication with the outlet-side fluid delivery arrangement 200d via at least one thermal management duct 141. Each fluid delivery arrangement 200 comprises first and second fluid connection arrangements for allowing a thermal management fluid to enter and/or exit the thermal management arrangement 140.

The battery module 10 further comprises a battery module electrical connection arrangement 160 for providing electrical connections between the battery module 10 and a component such as a further battery module 10, a busbar and/or an external load 1100. The battery module further comprises a battery module housing 100 and the cells 120 are located within the battery module housing 100.

The battery module 10 is locatable within a battery pack 1 and can be connected to one in or more further identical battery modules 10 also located within the battery pack 1. As will be explained in more detail below, the battery module 10 comprises an electrical connection arrangement 160 configured to allow electrical connections to be made to the battery module 10 in a plurality of locations. There being multiple locations where the battery module 10 can have electrical connections made thereto allows the battery module 10 to be employed in various battery pack designs. Furthermore, the thermal management arrangement 140 of the battery module allows fluid connections to be made to the battery module 10 in a plurality of locations.

There being multiple locations where the battery module 10 can nave electrical and fluid connections thereto allows the battery module 10 to be employed in various battery pack designs and is more adaptable than the prior art solutions.

The battery module housing 100 comprises an upper housing member 101 and a lower housing member 102. Each of the upper and lower housing members 101, 102 comprise a substantially planar base 103, two side walls 104a, 104b and two end walls 105a, 105b. The respective side walls 104a, 104b and end walls 105a, 105b extend in a direction which is substantially perpendicular to each base 103.

The side walls 104 of the upper and lower housing members 101, 102 comprise a plurality of recesses 106. The end surfaces of the upper and lower housing members 28, 27 also comprise a plurality of recesses 107. When the upper and lower housing members are brought together, as shown in FIG. 11a, the side wall recesses 106 form apertures 108 in the side walls of the housing through which electrical connections to the battery module terminals can be made. 4o Furthermore, the end wall recesses 107 form apertures 109 in the end walls of the battery module housing through which electrical and fluid connections can be made to the battery module.

The battery module 10 comprises an upper surface 110, a lower surface 111, two side surfaces 112 and two end surfaces 113 comprising end caps 114. The upper surface 111 is formed by the base 103 of the upper housing member 101. The lower surface 112 is formed by the base 103 of the lower housing member 102. The side surfaces 112 are formed by the side walls 104a, 104b of the upper and lower housing members and busbars 400 of the battery module 10. The end surfaces 113 are formed by the end walls 105sa, 105b of the upper and lower housing members 101, 102, the fluid delivery arrangements 200 and, in some embodiments, busbars 400.

The battery module 10 comprises an array of cylindrical cells 120 which may be 2170 cells and/or 18650 cells. The battery module 10 comprises a predetermined number of cells 120 arranged in a regular array. The battery module 10 is a multiple of six cells in length. The battery module 10 is twenty four cells long (four separator plates 180, each of which is six cells long). As shown in FIGS. 12a and 12b the cells 120 are provided in a close-packed hexagonal array. The minimum separation between the cells is 2 mm.

The battery module 10 comprises a thermal management arrangement 140 which is adapted to thermally manage (i.e. heat and/or cool) the cells 120. In this embodiment the thermal management arrangement 140 comprises a plurality of substantially parallel ducts 141 connected via fluid delivery arrangements 200. In preferred embodiments each duct 141 is a flexible duct formed from an inflatable plastics material such as polyethylene (PE), low-density polyethylene (LDPE), linear low-density polyethylene (LLDPE) or high-density polyethylene (HDPE). Use of an inflatable plastics material is advantageous as the material is intrinsically electrically insulating, lightweight and does not corrode or chemically interact with a coolant such as a glycol water mix.

In preferred embodiments each duct 141 comprises one or more thermally conductive additives. Thermally conductive additives provide the advantage that they can improve the thermal conductivity of the duct material. Ideally, each flexible duct 141 comprises a matrix (e.g. a flexible polymer material such as LDPE) with a thermally-conductive filler (e.g. particles of a carbon-based and/or ceramic based material such as graphite, multi-walled carbon nanotubes and/or boron-nitride) dispersed throughout the matrix. The particles have a diameter of 1-10 nm, most preferably <5 μm. In the most preferred embodiments the duct material comprises up to 30% additives. The filler material can be a blend of graphite and boron nitride particles according to any suitable ratio, for example 1.1. When incorporated into a PE matrix this provides a duct material having a thermal conductivity >=0.8 W/m K, optionally approximately 1 W/m·K.

The walls of each flexible duct 141 are between 50 μm and 150 μm thick. This thickness allows for good thermal transfer properties between the or each duct and the cells. In the preferred embodiments each duct 141 is a single-lumen duct but as will be appreciated a multi-lumen duct may be used in e.g. large battery packs where a single lumen duct is not capable of promoting an even temperature distribution in optional embodiments the ducts 141 may be rigid and made from e.g. aluminium or copper. In the example provided each duct 141 is a substantially straight manifold duct configured to carry a coolant fluid such as a water-glycol mixture, although each duct may follow a different path within the array of cells 120 and may be e.g. serpentine. The or each battery module 10 may include any number of ducts 141, for example one duct 141. The number of distribution conduits in each fluid delivery arrangement 200 in a battery module 10 may be chosen to match the number of ducts 141.

As shown in FIGS. 12a and 12b each flexible duct 141 is positioned adjacent to and between cells 120 in the battery module 10. During manufacture of the battery module 10, each duct 141 is located within the array of cells in a substantially uninflated state (FIG. 12a). Once suitably arranged, each duct 141 is then inflated using a coolant fluid which causes the duct to expand into contact with the side walls of the cells 120. Each duct 141, when in the inflated state, makes intimate physical contact with the surface of one or more cells 120. Inflating each flexible duct 141 such that its shape conforms to the shape of the cells 120 improves the duct-cell thermal contact such that the coolant fluid may transfer thermal energy between the coolant fluid and the cells 120 more efficiently.

Each duct 141 may be in direct contact with side surfaces of the adjacent cells 120, or may be in indirect contact with side surface(s) of the one or more cells via an interface region or interface material such as a casing sheath surrounding the cells 120. Alternatively or additionally each duct 141 may be in indirect contact with side surfaces of the one or more cells 120 via a thermally conductive filler material such as a conductive paste or adhesive.

Once the ducts 141 are in their inflated state and at a sufficient pressure, a potting material 130 is inserted into the battery module 10. The potting material 130 is poured into the battery module 10 in a liquid state and sets, cures or hardens. In its set, cured or hardened state, the potting material 130 is substantially rigid such that it secures the cells 120 and the ducts 141 in position within the battery module 10. This is advantageous as it reduces the effects of vibrations on components within the battery module 10. Once set cured and/or hardened, the potting material 130 is adhesively attached to each duct 141, providing total external support and preventing excessive expansion and/or bursting of each duct 141. Furthermore, the potting material 130 maintains each duct 141 in an open configuration such that thermal management fluid is able to flow easily through each duct 141.

In preferred embodiments the potting material 130 is a thermally-insulating potting material such as intumescent/polyurethane foam. Polyurethane foam is lighter than other potting materials and therefore provides a battery module 10 having a low overall weight. The presence of a thermally insulating potting material 130 within the battery module 10 reduces the effect of external temperature fluctuations on the battery module 10, helps to ensure that the ducts 141 are the primary controller of thermal energy within the battery module 10, and can prevent a high energy thermal event from propagating through the battery module 10. The potting material 130, when in the expanded state, substantially fills gaps within the battery module 10. In optional embodiments the potting material 130 comprises a thermosetting plastic, silicone rubber gel or epoxy resin.

FIG. 13a shows a detail of two rows of cells 120 between which is a duct 141. In preferred embodiments sensors are used to measure the temperature of the cells 120. Sensors 126 such as temperature sensors may be located on a flexible carrier 125, which is a flexible PCB, and the flexible carrier may be attached to the duct 141 as shown in FIG. 13b. In use, sensors 126 on the carrier 125 are located between the duct 141 and the cells 120 such that the sensors are able to measure e.g. the temperature of the cells. In the inflated state the duct presses the temperature sensor against a cell to ensure good thermal contact between the duct and the cell. The carrier 125 comprises conductive traces to allow the sensors 126 to be operably connected to e.g. the slave board 51 of the battery module 10 allowing the temperature of the cells to be transmitted to and analysed by a g, the battery management computer 50.

FIGS. 14a and 14b disclose front and rear perspective views of a fluid delivery arrangement 200 according to an aspect of the invention. Each battery module 10 comprises two fluid delivery arrangements 200 (see e.g. fluid delivery arrangements 200c and 200d in FIG. 10). Each duct 141 in a battery module 10 is connected to each fluid delivery arrangement 200 in the battery module 10. The fluid delivery arrangement 200 is adapted for delivering a thermal management fluid 1006 to thermal management ducts 141 locatable within the battery module 10 and battery pack 1.

The fluid delivery arrangement 200 comprises: a primary conduit 210 adapted to provide a path for fluid into and/or out of the fluid delivery arrangement 200, and a plurality of distribution conduits 220 adapted to provide a path for fluid out of and/or into the fluid delivery arrangement 200, and into and/or out of the thermal management ducts 141. Each distribution conduit 220 is in fluid communication with the primary conduit 210 via a main chamber 230, as shown in the cross-sectional view of FIG. 15.

The fluid delivery arrangement 200 comprises a body 201 which is formed of front and rear members 202, 203. The primary conduit 210 forms part of the front member 202. The front member 202 partially encloses the main chamber 230. Each distribution conduit 220 is attachable to the rear member 203 of the body 201. The rear member 203 partially encloses the main chamber 230 also. The main chamber 230 is located within the body 201 and is fully enclosed by the front and rear members 202, 203 which are sealably attached to one another.

When employed within battery pack 1, the fluid delivery arrangement 200 provides a means by which a thermal management fluid 1006 can be distributed within the battery pack 1, particularly to each battery module 10, in order to thermally manage the cells 120. Each fluid delivery arrangement 200 is a header tank which, in use, is operably connected to a plurality of ducts 141 within a battery module 10 and is also operably connected to one or more further fluid delivery arrangements 200 of the other battery modules 10 within the battery pack 1.

Turning to FIG. 15, the primary conduit 210 of the fluid delivery arrangement 200 provides multiple fluid paths into and/or out of the thermal management arrangement 140. In particular, the primary conduit 210 provides two fluid paths into and/or out of the main chamber 230. The primary conduit 210 comprises a first fluid connection arrangement (a fluid inlet) 211 and a second fluid connection arrangement (a fluid outlet)212. In use, the first fluid connection arrangement 211 of the primary conduit 210 provides a fluid path into the fluid delivery arrangement 200. The first fluid connection arrangement 211 of the primary conduit 210 is connectable to a source of thermal management fluid 1008 e.g. the reservoir 1001 in coolant loop 1005. In use, the second fluid connection arrangement 212 of the primary conduit 210 provides a fluid path out of the fluid delivery arrangement 200. The first fluid connection arrangement 211 and the second fluid connection arrangement 212 are substantially identical.

The first fluid connection arrangement 211 is provided at a first end 213 of the primary conduit 210. The second fluid connection arrangement 212 is provided at a second end 214 of the primary conduit, opposite the first end 213. As will be appreciated a fluid inlet and/or fluid outlet can be provided at either end of the primary conduit 210.

The primary conduit 210 comprises a primary conduit wall 215 which has a regular cross section i.e. the cross section of the primary conduit 210 is substantially constant along the main or major axis A of the primary conduit 210. The main axis A of the primary conduit 210 extends along the length of the primary conduit 210 and is substantially parallel to the direction of fluid flow through the primary conduit 210 from the first fluid connection arrangement 211 to the second fluid connection arrangement 212.

The first fluid connection arrangement 211 and second fluid connection arrangement 212 of the primary conduit 210 both comprise flanges 216. Each flange 216 is a retaining arrangement for a seal 60. Each flange 216 is a seal-receiving body comprising a channel 217. Each channel 217 is adapted to receive and retain part of a sealing arrangement 60 i.e. an o-ring 60. Each channel 217 has a predetermined depth suitable for receiving a retainable portion 603 of the o-ring 60.

The main chamber 230 of the fluid delivery arrangement 200 is adapted to contain and confine a thermal management fluid as it flows through the fluid delivery arrangement 200. The main chamber 230 is in fluid communication with the primary conduit 210 and each distribution conduit 220. The main chamber 230 is located within a space defined by a main chamber wall 231.

The fluid delivery arrangement 200 comprises at least one perforable region 240, 250 for providing an alternative fluid path for a thermal management fluid to pass into and/or out of the fluid delivery arrangement 200. As shown n FIG. 14b perforable regions 240, 260 are located in the wall 231 of the main chamber 230. In this example the wall 230 comprises two perforable regions 240, 250. Each perforable region 240, 250 is configured to provide a further and/or alternative path for fluid into and/or out of the main chamber 230 of the fluid delivery arrangement 200, as an addition or alternative to the primary conduit 210.

In the disclosed embodiment each perforable region 240, 250 is substantially planar and comprises a substantially circular peripheral region 241, 251. Around each peripheral region 241, 251 is provided a reinforcement member which is a tubular section 242, 252. Each tubular section has a main or major axis C, D which is substantially perpendicular to the plane of the perforable region 240, 250 and perpendicular to the main axis A of the primary conduit 210. The main axis B of each distribution conduit 54 is substantially parallel to the main axes C, D of the tubular sections 242, 252. The plane of each perforable region 240, 250 is substantially perpendicular to the plane of the first fluid connection arrangement 211 and second fluid connection arrangement 212 of the primary conduit 210.

In the unperforated state the perforable region 240, 250 sealably covers the respective tubular section 242, 252 and prevents fluid within the main chamber 230 from passing into and/or out of the main chamber 230. When either perforable region 240, 260 is perforated by e.g. performing a drilling operation, fluid is able to pass out of the main chamber 230 via an aperture 243, 253 formed in the perforable region 240, 250. As will be appreciated, the wall 231 of the main chamber may be thinner in the perforable regions 250 compared to the surrounding region, particularly the reinforcement members 242, 252, making each perforable region 240, 250 easier to perforate. Each reinforcement member 242, 252 is thicker than the surrounding wall 231 of the main chamber, in order to prevent or reduce the likelihood of a perforation in a perforable region 240, 250 becoming larger than the respective perforable region 240, 250.

The fluid delivery arrangement 200 comprises a plurality of distribution conduits 220. Each distribution conduit 220 comprises a body 221 which is attached to the fluid delivery arrangement 200, particularly to the wall 231 of the main chamber 230.

The rear member 203 of the fluid delivery arrangement 200 comprises a plurality of aligned distribution apertures 204 through which fluid can flow between the main chamber 230 and the distribution conduits 220. In the examples shown in FIGS. 14a and 141 the rear member 203 comprises eight distribution apertures 204 and eight distribution conduits 220 attached to the rear member 203. Each distribution conduit 220 is adapted to allow fluid to pass through said distribution conduit 220 and into and or out of a respective duct 141.

Each distribution conduit 220 comprises a fluid inlet 222 and a fluid outlet 223 to allow so thermal fluid to pass through the distribution conduit 220. In use, each fluid inlet 222 and fluid outlet 223 is in fluid communication with the main chamber 230 of the fluid delivery arrangement 200.

Each distribution conduit 220 comprises an attachment portion 224 which is attached to the wall 231 of the main chamber 230 via plastic welding. Each distribution conduit 220 comprises a duct attachment portion 225 which is sealably attachable to a duct 141. Each attachment portion 225 comprises a plurality of fins 226 which can be plastically welded to a duct 141 at an open end of the duct 141 to provide a fluid-tight seal thereto. In preferred embodiments, each distribution conduit 220 is attached to a thermal management duct 141 in a fluid-tight manner via welding.

FIG. 14a shows a spacing arrangement 280 associated with the fluid delivery arrangement 200. The spacing arrangement 280 is adapted to provide a free volume within the battery module 10 i.e. a volume devoid of potting material 130. The free volume allows components such as an electrical carrier to be located and easily accessed within the battery module 10. The spacing arrangement 280 also ensures that there will be a spacing between the fluid delivery arrangement 200 and other components in the battery module 10, particularly cells 120.

The spacing arrangement 280 is formed as a tray which is adapted to support cells 120 in the battery module 10. The spacing arrangement 280 is attachable to the fluid delivery arrangement 200. The spacing arrangement 280 comprises a plurality of recesses 281 which are sized to accommodate a cell 120. The spacing arrangement 280 can be used to retain a sensor 126 e.g. a temperature sensor in position against a cell wall 121. As shown in FIG. 14c, a temperature sensor 12e is located in the centre of recess 281. The temperature sensor 128 is connected to a flexible carrier 125 which is in turn connectable to the slave board 51 of a battery module 10. As shown in FIG. 14b, the stave board 51 is attached to the front member 202 of the fluid delivery arrangement body 201.

FIG. 16 is an exploded view of the fluid delivery arrangement 200 in a first configuration in which the primary conduit 210 is used to transport fluid to and/or from the main chamber 230. In this configuration the first fluid connection arrangement 211 and second fluid connection arrangement 212 of the primary conduit 210 are open so that fluid can pass into and out of the main chamber 230 via the primary conduit 210. In this configuration the perforable regions 240, 250 are unperforated and so fluid is unable to pass into the main chamber 230 via these routes.

When used in the configuration of FIG. 16, the first fluid connection arrangement 211 or second fluid connection arrangement 212 of the primary conduit 210 may be connected to a fluid outlet of a further fluid delivery arrangement, as shown in e.g. FIG. 17, in this case, the primary conduit 210 of a first fluid delivery arrangement 200 is connectable to a primary conduit 210a of a further fluid delivery arrangement 200a, which in turn is connectable to a yet further primary conduit 210b of a yet further fluid delivery arrangement 200b. When connected in this way the main chambers 230, 230a, 230b of each fluid delivery arrangement 200, 200a, 200b are in fluid communication with each other. A thermal management fluid is able to pass through the main chamber of each distribution arrangement successively. Sealing members 60 are used to seal the interfaces between the fluid connection arrangements of neighboring primary conduits 210, 210a, 210b. A sealing member 60 seats the gap between the second fluid connection arrangement 212 of the first fluid delivery arrangement 200 and the first fluid connection arrangement 211a of the further fluid delivery arrangement 200a. A further sealing member 60 seals the gap between the second fluid connection arrangement 212a of the further fluid delivery a arrangement 200a and the first fluid connection arrangement 211a of the yet further fluid delivery arrangement 200b Together, the joined primary conduits 210, 210a, 210b and seals 60 provide a sealed structure for transporting a thermal management fluid within a battery pack.

FIGS. 17a-17f disclose an alternative fluid delivery arrangement 1200 according to an aspect of the invention, with similar numerals (e.g. 200, 1200) denoting similar components. Particularly, the fluid delivery arrangement 1200 comprises: a primary conduit 1210 adapted to provide a path for fluid into and/or out of the fluid delivery arrangement 1200; and a plurality of distribution conduits 1220 adapted to provide a path for fluid out of and/or into the fluid delivery arrangement 1200, and into and/or out of the thermal management ducts 141. Each distribution conduit 1220 is in fluid communication with the primary conduit 1210 via a main chamber 1230.

The fluid delivery arrangement 1200 can be used in a similar way to the first embodiment, having perforable regions 1240, 1250 allowing a plurality of configurations. The distinguishing features of the second embodiment of the fluid delivery arrangement 1200 are the distribution conduits 1220. Furthermore, the second embodiment includes flanges 1216/sloped surfaces 1218, the function of which is explained in further detail below with respect to FIGS. 20a-20c.

Each distribution conduit 1220 comprises an attachment portion 1224 which is attached to the wall 1231 of the main chamber 1230 via plastic welding, and a duct attachment portion 1225 which is sealably attachable to a duct 141. Each duct attachment portion 1225 comprises a plurality of fins 1226 which can be plastically welded to a duct 141 at an open end of the duct 141 to provide a fluid seal thereto. The attachment portion 1224 of the second embodiment is shorter than that of the first embodiment (224, FIG. 15), leading to each distribution conduit 1200 being shorter along the axis B. This shortening allows more space within the battery module for cells.

FIG. 18a shows in detail a sealing member 60 for providing a seal between fluid conduits in a battery pack 1 and/or between battery modules 10. The sealing member 60 comprises a deformable annular body 801. The body 601 comprises first and second elongate side portions 604a, 604b, and first and second shortened side portions 605a, 605b. The cross-sectional shape of the body 801 comprises a central portion 602 located between first and second retainable portions 603a, 603b. By cross-sectional shape it is meant the shape of the body 601 when viewed in cross-section, in particular the cross section when cutting through the body in the X-Z plane (see FIGS. 19a and 19b, central panels). The cross-sectional shape of the body 601 is constant throughout the body, particularly along the entire length of each side portion 604a, 604b, 605a, 605b. The cross-sectional width of the central portion 602 (corresponding to the cross-sectional width of the elongate side portions 604a, 604b along the X-axis direction) is greater than the cross-sectional width of each retainable portion 603a, 603b.

The sealing member 60 is an o-ring. The unitary body 601 is made from soft silicone or other suitable resilient material, such as rubber. The purpose of the sealing member 60 is to seal the interfaces between interconnected fluid-carrying conduits within the battery pack 1, and to prevent fluid leaks. The present application requires the sealing member 60 to have an appropriate hardness. Softer sealing materials, with lower shore A hardness readings, will flow more easily into gaps, grooves and imperfections between mating parts (flanges 216) and may be extruded or blown through such gaps, resulting in seat failure. While harder materials with higher shore A hardness ratings will offer greater resistance to extrusion, they will also require larger compressive forces for sealing it has been found that the deformable body 601 should ideally have a shore A hardness of less than 50 and greater than 15. In some preferred embodiments the deformable body 601 has a shore A hardness of between 30 and 40, in the most preferred embodiments the deformable body has a shore A hardness of between 33 and 37, particularly 35.

As shown in the side views of FIGS. 19a, 19b (upper panels) body 601 comprises a central portion 602 located between two retainable portions 603a, 603b. The retainable portions 603a, 603b are adapted to be located and retained within a retaining member, for example the channels 217 formed in the flanges 216 of the fluid delivery arrangement 200. The central portion 602 is adapted to expand or widen under compressive force, thereby sealing a gap or space between e.g. two retaining members.

As shown in the cross-sectional views of FIGS. 19a, 19b (central panels) the cross-sectional shape of each retainable portion 603a, 603b comprises two substantially straight edge portions 613 joined by a curved and/or semicircular edge portion 623. The central portion 602 comprises two curved and/or semicircular edge portions 623. When squeezed or otherwise deformed under a compressive force (acting along the Z axis), the edge portions 612, 622 become bowed and move apart from each such that the width of the central portion 602 increases.

As shown in the top views of FIGS. 19a, 19b (lower panels) the sealing member body 601 is substantially rectangular comprising four substantially straight side portions 604a, 604b, 605a, 605b that are joined by corner portions 606a-d. Opposing side portions, for example the elongate side portions 604a, 604b, are substantially parallel and are of equal length. Each side portion 604a, 604b, 605a, 605b is joined to a neighbouring side portion by a smooth corner portion 606a-d. The substantially rectangular body 601 comprises two elongate side portions 604a, 604b (extending along the Y-axis direction), two short side portions 605a, 605b (extending along the X-axis direction) and four corner portions 606a-d. The substantially rectangular shape of the body 601 corresponds to the shape of the retainment channels 217 in the flanges 216.

FIG. 18a shows the sealing member 60 in its undeformed state 60a. The undeformed state shown in FIG. 18a is the default state of the sealing member 60, representing the shape that the sealing member 60 adopts when no forces, such as compressive forces, are applied to the sealing member 60.

FIG. 18b shows the sealing member 60 in its in-use deformed state 60b. The deformed state shown in FIG. 18b represents the shape that the sealing member 60 adopts when a longitudinal compressive force is applied to the sealing member 60. The longitudinal compressive force is applied along a direction that is parallel to the direction between the retainable portions 803a, 603b. i.e. parallel to axis Z shown in FIGS. 19a, 19b (central panels).

In use, the sealing member 60 is used as a seal and a compressive force is applied to the sealing member 60. The retainable portions 603a, 603b are located and retained within retaining members, e.g. the channels 217 in the flanges 216 of the fluid delivery arrangement 200. A compressive force is applied to the seating member 60. This force acts to push the retainable portions 603a, 603b together, along a direction that is parallel to the axis Z shown in FIGS. 19a and 190 (central panels). The sealing member 60 enters the deformed state when it is located within and squeezed between first and second retaining arrangements, e.g. the channels 217 of neighbouring fluid delivery arrangements 200. In the deformed state shown in FIGS. 18b and 19b, the central portion 602 has an increased cross-sectional width. The cross-sectional width of the central portion 802 in the deformed state 80b is greater than the cross-sectional width of the central portion 602 in the undeformed state 60a. The cross-sectional width of the retainable portions 603a, 603b in the deformed stated is substantially the same as the cross-sectional width of the retainable portions 603a, 603b in the undeformed state, due to the fact that these portions are held within the channels 217 and are prevented from expanding or widening in a similar manner. The increased width of the central portion 602 in the deformed state allows the sealing member 60 to accommodate any slight differences in size/dimensions of the respective channels/flanges of the fluid delivery arrangements 200 between which the sealing member 60 is retained.

In the most preferred embodiments, in the undeformed state the cross-sectional width of the central portion is 2.8 mm and the cross-sectional width of each retainable portion is 1.8 mm. In the undeformed state the cross-sectional height of the sealing means is 18 mm. In the deformed 75 state the cross-sectional width of the central portion is greater than 2.8 mm, most preferably 4.4 mm, and the cross-sectional width of each retainable portion is 1.8 mm. In the deformed state the cross-sectional height of the sealing means is less than 18 mm, most preferably 14.4 mm.

FIG. 20a shows a perspective view of two front members 202a, 202b of a fluid delivery arrangement 200 according to the invention. The front members 202a, 202b shown in FIG. 20a are compatible with the rear members 203 previously disclosed. The primary conduits 210a, 210b of the front members 202a, 202b are operably connected to one another and a sealing member 60 is located between and retained within the respective flanges 216a, 216b.

Each flange 216a, 216b is formed to have two sloped surfaces 218a, 218b, the slopes of 3 degrees depending from the centre to the edge of the flanges 216a, 216b. The sloped surfaces are substantially opposite the surface of each flange 216a, 216b in which the channel 217a, 217b is formed.

When the neighbouring flanges 21ea, 216b are brought together and a sealing member 60 is retained therebetween, two clamping members 219a, 219b are located over the flanges and bear against the sloped surfaces 218a, 218b. The clamping members 219a, 219b are tied together using a fastening loop 232 such as a cable tie. As the fastening loop 232 is tightened, the clamping members push the sloped surfaces 218a, 218b, and therefore the flanges 216a, 216b, together. This increases the force which acts on the sealing member 60, and therefore the seal between the primary conduits 210, 210a. The interior surfaces of the clamping members 219a, 219b are outwardly tapered at the same angle as the sloped surfaces 218a, 218b.

FIG. 21a discloses an alternative configuration of the fluid delivery arrangement 200 in which an aperture 243, 253 is formed in each perforable region 240, 250. In this configuration, the fluid delivery arrangement comprises alternative fluid paths into the main chamber. The alternative fluid paths, which are secondary conduits 260, 270 (first and second fluid connection arrangements), are provided by the tubular sections 242, 252, the apertures 243, 253 and fluid connectors 244, 254 which are attachable to the respective tubular sections 242, 252. The end of each connector 244, 254 is ideally plastic welded to ensure a tight fluid connection between the respective tubular section 242, 252 and connector 244, 254.

In the configuration shown in FIG. 21a fluid is unable to pass into the main chamber 230 via the primary conduit 210, and fluid can only pass into the main chamber via the secondary conduits 260, 270. In the embodiment of FIG. 21 the first fluid connection arrangement 211 and second fluid connection arrangement 212 of the primary conduit 210 are closed by blanking plates 233. The blanking plates 233 prevent fluid from passing into and/or out of the primary conduit 210. The blanking plates may be sealably attached to the first fluid connection arrangement 211 and second fluid connection arrangement 212 using sealing members 60.

The fluid delivery arrangement 200 is more flexible and adaptable than prior art designs due to the fact that multiple fluid paths can be provided into the main chamber 230. The designer of a battery pack 1 can adapt each module 10 to have fluid connections in a multitude of positions and orientations. In the ‘stacked’ arrangement of modules 10 shown in e.g. FIG. 1 it is envisaged that the designer will use the primary conduits 210 to transport coolant fluid to cells 120. The ability to provide alternative perpendicular fluid paths into the main chambers 230 using the secondary conduits 260, 270 means that the same battery modules 10 can be employed in an alternative ‘flat pack’ arrangement, as shown in FIG. 22a. As will be appreciated the stacked and flat pack arrangements are merely examples of possible arrangements of the battery modules in a battery pack, and many more are possible.

Returning to FIGS. 21a and 21b, each secondary conduit 260, 270 comprises a fluid inlet 261, 271 and a fluid outlet 262, 272. The fluid inlet 261, 271 of each secondary conduit 260, 270 is located at a first end 263, 273 of the secondary conduit 260, 270 and provides a fluid path into the fluid delivery arrangement 200. The fluid outlet 262, 272 of each secondary conduit 260, 270 is located at a second end 284, 265 of the secondary conduit 260, 270 and provides a fluid path out of the fluid delivery arrangement 200. The fluid inlet 261, 271 of each secondary conduit 260, 270 is connectable to a source of thermal management fluid e.g. the reservoir 1001 in coolant loop 1005.

As will be appreciated the fluid inlets 261, 271 and fluid outlets 262, 272 of the secondary conduits are interchangeable and may be located at either end of the respective secondary conduit 280, 270. One or two secondary conduits 260, 270 may be used in a given application in the case where only one secondary conduit is used, the other secondary conduit may be closed off e.g. there may be no aperture in the respective perforable region. In other words, only one of the perforable regions 240, 250 may be perforated. Furthermore, one or more of the secondary conduits may also be closed via a blanking plate 233.

Each secondary conduit 260, 270 comprises a secondary conduit wall 265, 275. Each secondary conduit 260, 270 has a main axis E, F. Each secondary conduit 260, 270 has a regular and preferably circular cross section along its main axis E, F. The main axis E, F of each secondary conduit 260, 270 extends along the length of the secondary conduit 280, 270. The main axis E, F of each secondary conduit 260, 270 is substantially parallel to the direction of fluid flow through the secondary conduit 280, 270 from the inlet 261, 271 to the outlet 262, 272 thereof. When in use, each secondary conduit 260, 270 is in fluid communication with the main chamber 230 and extends in a direction which is substantially perpendicular to the primary conduit 210. The main axis A of the primary conduit 210 is substantially perpendicular to the main axes E, F of the secondary conduits 260, 270.

Each battery module 10 comprises a battery module electrical connection arrangement 160 for providing electrical connections between the battery module 10 and a component such as a further battery module 10, a busbar, an interconnect and/or an external load. The battery module electrical connection arrangement includes a collection of battery module busbars 170 which are used to electrically interconnect the cells 120, and the battery module terminals 171, 172. Each battery module busbar 170 is formed of a single metallic sheet, such as an aluminium or steel sheet, which has been formed into a predetermined shape. The battery module busbars 170 are themselves electrically interconnected via wire bonds 173 and/or cells 120.

FIG. 23a shows a battery module 10 with the housing members removed. The battery module 10 comprises a plurality of interconnection busbars 300 and two non-planar busbars 400. As shown in FIG. 23b, each cell 120 in battery module 10 is electrically connected to the battery module busbars 170 via wire bonds 173 which are fusible and/or frangible electrical connections. Wire bonds are made to the busbars 170/cells using ultrasonic bonding, laser welding, ultrasonic welding or resistance welding. In preferred embodiments each wire bond 173 is an aluminium or steel wire bond and each battery module busbar 170 is made from aluminium or steel.

FIG. 24a shows an interconnection busbar 300 for use in the battery module 10. Each interconnection busbar 300 is generally planar and cut or pressed from sheet metal. The interconnection busbar 300 comprises a body 301 having edge portions 302. As shown in FIG. 24b, each edge portion 302 comprises one or more recesses 303. When in situ within the battery module, the recesses 303 provide gaps through which potting material 130 can be inserted into the battery module 10. In the case where a single wide interconnection busbar 300 is used to connect to all of the cells in a battery module, the recesses 303 may be replaced with potting apertures 304 in the body 301 located away from the edge portion 302 (see the larger busbar 300a of FIG. 24c).

The body 301 comprises a planar cell connection portion 310 adapted to be connectable to the terminals/casings of one or more cells 120 via wire bonds 173. The cell connection portion 310 comprises a plurality of cell connection apertures 311. The cell connection apertures 311 are generally rectangular although any suitable shape may be used. The cell connection apertures 311 are adapted to allow a wire bond 173 to pass fully therethrough. The cell connection apertures 311 are arranged in a close-packed hexagonal or honeycomb pattern, reflecting the arrangement of cells 120 within the battery module 10. The interconnection busbar 300 also comprises fixing apertures 312 to allow the busbar 300 to be fixed in position within the battery pack 10. The fixing apertures 312 are located in the cell connection portion 310. Fastening arrangements such as screws can pass through the fixing apertures 312.

FIG. 25a provides a perspective view of a busbar 400 according to an aspect of the invention. The busbar 400 has a unitary construction, is generally non-planar and is cut or pressed from sheet metal and bent into a desired final shape. The non-planar busbar 400 comprises a body 401. The body 401 comprises a number of portions 420, 430, 440. The busbar 400 is used in the battery module 10 and battery pack 1 to provide electrical connections to the cells within a battery pack 1 and/or battery module 10. Non-planar busbars 400 are used to form the elongate positive and negative terminals 171, 172 of the battery module 10. The busbar 400, like other busbars employed in battery pack 1, is formed from an electrically-conductive material such as aluminium or steel.

The busbar 400 shown in FIG. 25a comprises a cell connection portion 410 and a primary external connection portion 420. The cell connection portion 410 is adapted for connection to the terminals of one or more cells. The primary external connection portion 420 is adapted for providing electrical connection to a further component such as a further busbar, a terminal, an interconnect and/or an external load. The cell connection portion 410 is disposed at an angle to the primary external connection portion 420. In the present embodiment the cell connection 3o portion 410 is substantially perpendicular to the primary external connection portion 420. The angle between these portions means that the busbar is adapted to receive the edge of an array of cells, particularly the corners of the cell casings. In use, the busbars 400 are located at the edge of the array of cells in battery module 10.

The body 401 of busbar 400 comprises a generally planar cell connection portion 410 adapted to be connectable to the terminals and/or casings of one or more cells 120 via wire bonds 173. The cell connection portion 410 comprises a plurality of cell connection apertures 411. The cell connection apertures 411 are generally rectangular although any suitable shape may be used. The cell connection apertures 411 are adapted to allow a wire bond 173 to pass fully therethrough. The cell connection apertures 411 are arranged in a close-packed hexagonal or honeycomb pattern, reflecting the arrangement of cells 120 within the battery module 10. The cell connection portion 410 comprises first and second rows 411a, 411b of cell connection apertures 411, but in optional embodiments more or fewer rows may be used. The busbar 400 also comprises fixing apertures 412 to allow the busbar 400 to be fixed in position within the battery pack 10. The fixing apertures 412 are located in the cell connection portion 410. Fastening arrangements such as screws can pass through the fixing apertures 412.

The body 401 further comprises a primary external connection portion 420. The primary external connection portion 420 is a terminal portion adapted for connection to an external load. The primary external connection portion 420 comprises a generally planar main plane portion 422 and a plurality of raised portions 421. The raised portions 421 are adapted for providing electrical connection to a further component such as a further busbar, a terminal, an interconnect or an external load. The raised portions 421 are generally planar and are slightly raised above the main plane 422 of the primary external connection portion 420. Each raised portion 421 is formed to be accessible through the housing walls of a battery module 10 i.e. through the apertures 108.

Each raised portion 421 is integrally formed in the primary external connection portion 420 and is formed via pressing. Each raised portion 421 comprises a planar portion 422 surrounded by a curved peripheral portion 423. Each raised portion 421 further comprises a retaining arrangement 424 in the form of a threaded hole. Each retaining arrangement 424 is adapted to retain a fixing member such as a bolt, allowing e.g. an intermodule busbar 38 to be rigidly attached to the busbar 400.

The body portion 401 further comprises secondary external connection portions 430, 440. The secondary external connection portions 430, 440 are adapted for providing electrical connections to a further component such as a further busbar, a terminal, an interconnect and/or an external load. The secondary external connection portions 430, 440 are both generally planar and located at either end of the primary external connection portion 420. Each of the secondary external connection portions 430, 440 comprises a retaining arrangement 433, 443 in the form of a threaded hole. Each retaining arrangement 433, 443 is adapted to retain a fixing means such as a bolt, allowing e.g. a C-shaped intermodule busbar 38 to be rigidly attached to the busbar 400. The secondary electrical connection portions 430, 440 are both disposed at an angle to the primary external connection portion 420 and the cell connection portion. In the present embodiment the secondary electrical connection portions 430, 440 are both perpendicular to the primary external connection portion 420 and the cell connection portion.

In use, the busbar 400 is located within a battery module 10. The array of cells 120 within the battery module 10 is located within the volume between the portions of the busbar 400. The internal corner of the busbar 40 between the cell connection portion and the primary electrical connection portion 420 is angled to accommodate the corner of a cell, or an array of cells. The primary and secondary electrical connection portions 420, 430 and 440 can be made accessible from the exterior of the battery module 10, so that electrical connections to a g, an external load can be made to the busbar 400. This allows the battery module 10 to be electrically connected to other components in a plurality of locations and orientations. The battery module 10 in which the busbar 400 is employed comprises a housing and at least the primary external connection portion of the busbar is accessible through a side wall of the housing. Particularly, the raised portions of the primary external connection portion pass through apertures in the side walls of the battery module housing. In optional embodiments suitable apertures are provided in each battery module such that the primary and secondary electrical connection portions are accessible from the exterior of the battery module 10. The non-planar shape of the busbar 400 provides added structural integrity to the battery module 10 and structural supports can be fixed to the busbars 400. Battery modules 10 comprise two non-planar busbars 400 that are accessible through the battery module housing on opposing sides of the battery module housing.

The designer of a battery pack 1 can adapt each battery module 10 to have electrical connections in a multitude of positions and orientations. In the ‘stacked’ arrangement of modules shown in e.g. FIG. 1 it is envisaged that the designer will connect neighbouring battery modules using intermodule busbars 36 connected to the primary electrical connection portions 420. The ability to provide electrical connections at alternative positions (i.e. at the secondary electrical connection portions 430, 440 using C-shaped intermodule busbars 38) means that the same battery modules 10 can be employed in an alternative ‘flat pack’ arrangement, as shown in FIG. 22a. As will be appreciated the stacked and flat pack arrangements are merely examples of possible arrangements of the battery modules in a battery pack 1, and many more are possible.

Cell arrangement members 180 are used within battery modules 10 for supporting and locating the plurality of cells 120. FIG. 27a discloses an example cell arrangement member 180 comprising a substantially planar body 181 and a plurality of receiving formations 182 formed in the body 181. Each receiving formation 182 is adapted for receiving and locating the end of a cell 120 within the battery module 10.

The receiving formations 182 are arranged in a close-packed hexagonal or honeycomb pattern. The receiving formations 191 are adapted to hold cells 120 in a close-packed hexagonal or honeycomb pattern within the battery module 10. Each receiving formation 182 comprises a through hole portion 183 and a rim portion 184. Each rim portion 184 is formed by a stopped hole which passes part of the way through the body 181 of the member 180. Each rim portion 184 is circular having the same centre as, but a larger radius than, the through hole portion 183. The end 122 of a cell 120 rests against the rim portion 184. The rim portion 184 prevents the cell 120 from passing through the body 181 of the member 180. The through hole portions 183 pass completely through the body 181. The through hole portions 183 provide a path through which a wire bond 173 can pass so that said wire bond 173 can electrically connect a busbar on one side of the member 180 with the cells 120 on the other side of the member 180.

The planar body 181 of the cell arrangement member 180 comprises two straight edges 185a, 185b and two curved edges 186a, 186b. The curved edges 186a, 186b are on opposing sides on the body 181 and the curved edges 186a, 186b are joined by straight edges 185a, 185b. The curved edges are formed in a repeating pattern of protrusions 187 and recesses 188. Each protrusion 187 on the first curved edge 185 is directly opposite a recess 188 on the second curved edge. The curved edges 185, 186 are formed such that the first curved edge 186a of a first cell arrangement member 180 fits into the second curved edge 186b of a second cell arrangement member 180a, and vice verse, while the straight edges 185a, 185b of the neighbouring members 180, 180a are substantially aligned.

The receiving formations 181 are spaced apart in an arrangement which will ensure that there are sufficient gaps between the cells 120 to allow a duct 141 and/or potting material 130 to be located between the cells 120. The cell arrangement member 180 can be made in any size to suit the width and length of the battery module 10. The cell arrangement member 180 comprises a multiple of six receiving formations 182. The cell arrangement member 180 is six receiving formations 182 wide.

In use each cell arrangement member 180 is located between the end 122 of a plurality of cells 120 and a cell connection portion 310, 410 of a busbar 300, 400. Each cell arrangement member 180 is electrically insulating and thereby electrically insulates the busbars 300, 400 from the array of cells 120. Each battery module 10 comprises a plurality of cell arrangement members 180 to hold the cells 120 in position. Each cell 120 is held within the battery module 10 between two cell arrangement members 180. An example of a plurality of cells 120 being associated with a cell arrangement member 180 is shown in FIG. 27a.

As will be understood by the skilled person, the example embodiments presented above can be modified in a number of ways without departing from the scope of the invention. For example, the battery modules 10 can have any suitable length, width, height and/or number of cells 120 and the battery module sub assembly 3 can include any appropriate number of specifically-designed battery modules 10 for the particular application required. The or each busbar may be made from any suitable material such as aluminium or steel.

When adjusting the size of the battery modules 10 only a subset of the components need to be specifically engineered to allow packs having different lengths and number of cells. For example FIG. 28a discloses an alternative battery module 510. The alternative battery module 510 has the same width and height as the battery module 10, but has a different length and more cells. The fluid delivery arrangements 200 in the alternative battery module 510 are identical to those of the battery module 10 but the housing members, busbars, and ducts are all of increased length. A battery module 610 can be constructed having arbitrary length by adjusting the sizes of the housing members, busbars (e.g. 530,300,620—see FIG. 28b) and ducts while keeping a fixed width and height.

The battery pack housing 2 may include a potting material 130 which holds e g, the battery module sub-assembly 3 in place and/or supports and locates components within the battery housing 2. The battery modules 10 can be connected in a plurality of configurations in order to satisfy a particular set of design requirements. For example, some or all of the battery modules can be electrically connected in series and/or the fluid connections can be made in series.

Each battery module may include any suitable number of sensors, such as any combination of temperature sensors, strain sensors, pressure sensors, volatile organic compound (VOC) sensors, carbon monoxide (CO) sensors, carbon dioxide (CO2) sensors, smoke sensors, leak detectors, acceleration sensors, microelectromechanical systems (MEMS) sensors, voltage, heat and moisture detection sensors.

In the preceding discussion of the invention, unless stated to the contrary, the disclosure of alternative values for the upper or lower limit of the permitted range of a parameter, coupled so with an indication that one of the values is more highly preferred than the other, is to be construed as an implied statement that each intermediate value of the parameter, lying between the more preferred and the less preferred of the altematives, is itself preferred to the less preferred value and also to each value lying between the less preferred value and the intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof.

1. A battery module comprising one or more cells and a thermal management means for thermally managing the one or more cells, wherein the thermal management means comprises at least one thermal management duct, an intake-side fluid delivery means and an outlet-side fluid delivery means, wherein the inlet-side fluid delivery means is in fluid communication with the outlet-side fluid delivery means via the at least one thermal management duct and wherein each fluid delivery means comprises first and second fluid connection means for allowing a thermal management fluid to enter and/or exit the thermal management means.

2. A battery module according to claim 1 wherein each fluid delivery means comprises at least one distribution conduit.

3. A battery module according to claim 2 wherein each fluid delivery means comprises a plurality of distribution conduits.

4. A battery module according to claim 2 or claim 3 wherein the or each distribution conduit is attached to a thermal management duct.

5. A battery module according to claim 4 wherein the or each distribution conduit is attached to a thermal management duct in a fluid-tight manner.

6. A battery module according to claim 4 or claim 5 wherein the or each distribution conduit is attached to a thermal management duct via welding.

7. A battery module according to any preceding claim wherein at least one fluid delivery means comprises a primary conduit.

8. A battery module according to claim 7 wherein a first fluid connection means is provided at a first end of the primary conduit.

9. A battery module according to claim 8 wherein a second fluid connection means is provided at a second end of the primary conduit.

10. A battery module according to claim 9 wherein the first end of the primary conduit is opposite the second end of the primary conduit.

11. A battery module according to any one of claims 7 to 10 wherein the primary conduit extends along an axis.

12. A battery module according to any preceding claim wherein the first fluid connection means and/or the second fluid connection means comprises attachment means.

13. A battery module according to claim 12 wherein the or each attachment means comprises a flange.

14. A battery module according to claim 12 or claim 13 wherein the or each attachment means comprises a channel for a receiving a seal.

15. A battery module according to any preceding claim wherein each fluid delivery means comprises a main chamber.

16. A battery module according to claim 15 wherein each main chamber is in fluid communication with a primary conduit.

17. A battery module according to claim 15 or claim 16 when dependent on any one of claims 2 to 6 wherein each main chamber is in fluid communication with a distribution conduit.

18. A battery module according to any preceding claim wherein the inlet-side fluid delivery means and the outlet-side fluid delivery means are substantially identical.

19. A battery module according to any preceding claim wherein the thermal management means comprises a plurality of thermal management ducts.

20. A battery module according to any preceding claim wherein the or each thermal management duct is flexible and/or inflatable.

21. A battery module according to any preceding claim wherein the or each thermal management duct is made from an inflatable plastics material.

22. A battery module according to any preceding claim wherein the or each thermal management duct is positioned adjacent to and/or between cells in the battery module.

23. A battery module according to claim 22 wherein the or each thermal management duct is in an expanded state such that said thermal management duct has a shape which conforms to the surface shape of one or more cells.

24. A battery module according to any preceding claim wherein the battery module comprises a potting means.

25. A battery module according to claim 24 wherein the potting means comprises a thermally-insulating potting material such as intumescent polyurethane foam.

26. A battery module according to any preceding claim wherein the battery module comprises one or more spacing means.

27. A battery module according to claim 26 wherein the or each spacing means is a tray.

28. A battery module according to claim 26 or claim 27 wherein the or each spacing means is adapted to provide a free volume within a battery module.

29. A battery module according to any one of claims 26 to 28 wherein the or each spacing means is mechanically coupled to a fluid delivery means.

30. A battery module according to any preceding claim wherein the battery module comprises a plurality of cells.

31. A battery module according to any preceding claim wherein the battery module comprises one or more cylindrical cells.

32. A battery module according to any preceding claim wherein the battery module comprises a close-packed hexagonal array of cylindrical cells.

33. A battery module according to any preceding claim wherein the battery module comprises at least one cell arrangement means.

34. A battery module according to claim 33 wherein the or each cell arrangement means is a plate for supporting and locating a plurality of cells in an array.

35. A battery module according to claim 34 wherein the or each cell arrangement means comprises a plurality of receiving formations.

36. A battery module according to any preceding claim wherein the battery module comprises a battery module housing.

37. A battery module according to claim 36 wherein the battery module housing comprises an upper housing member and a lower housing member.

38. A battery module according to claim 37 wherein the upper housing member and lower housing member are substantially identical.

39. A battery module according to any one of claims 36 to 38 wherein the battery module housing comprises two opposing side walls.

40. A battery module according to any preceding claim wherein the battery module comprises a battery module electrical connection means for providing electrical connections between the battery module and a further electrical component such as a further battery module, a busbar, an interconnect and/or an external load.

41. A battery module according to claim 40 wherein the battery module electrical connection means comprises positive and negative terminals.

42. A battery module according to claim 41 when dependent on claim 39 wherein the positive and negative terminals are located on the opposing side walls of the battery module housing.

43. A battery pack comprising one or more battery modules according to any preceding claim.

44. A battery pack according to claim 43 wherein the battery pack comprises a plurality of battery modules.

45. A battery pack according to claim 43 or claim 44 wherein the battery pack comprises at least three battery modules.

46. A battery pack according to any one of claims 43 to 45 wherein the battery pack is located within a predetermined volume within an apparatus such as a mobile apparatus or an industrial apparatus.

47. A battery pack according to any one of claims 43 to 46 wherein the battery pack comprises a battery pack fluid connection means for connecting the battery pack to an external source of thermal management fluid.

48. A battery pack according to claim 47 wherein the battery pack fluid connection means comprises a battery pack fluid inlet and a battery pack fluid outlet.

49. A battery pack according to claim 47 or claim 48 wherein the thermal management means of the or each battery module in the battery pack are in fluid communication with the battery pack fluid connection means.

50. A battery pack according to any one of claims 43 to 49 wherein the inlet-side fluid delivery means of each battery module is in fluid communication with the inlet-side fluid delivery means of at least one other battery module.

51. A battery pack according to any one of claims 43 to 49 wherein the outlet-side fluid delivery means of each battery module is in fluid communication with the outlet-side fluid delivery means of at least one other battery module.

52. A battery pack according to any one of claims 43 to 51 wherein the battery pack comprises a battery module sub assembly, wherein the battery module sub assembly comprises a plurality of battery modules and wherein the battery modules in the battery module sub assembly are mechanically connected to one another.

53. A battery pack according to claim 52 wherein the battery module sub assembly comprises a support means and wherein the battery modules in the sub assembly are mechanically coupled to each other via the support means.
